(19) United States
(12) Patent Application Publication
(10) Pub. No.: US 2025/0367050 A1
(43) Pub. Date: Dec. 4, 2025

(54) Step Apparatus for Beds and the Like

(71) Applicant: Peak Degrees Holdings LLC, Trophy Club, TX (US)

(72) Inventor: Christopher Pesek, Trophy Club, TX (US)

(21) Appl. No.: 19/223,813

(22) Filed: May 30, 2025

Related U.S. Application Data
(60) Provisional application No. 63/653,302, filed on May 30, 2024.

(51) Int. Cl. A61G 7/053

(52) U.S. Cl. CPC A61G 7/053

(57) ABSTRACT

A step apparatus for beds and the like provides an elevated support surface. The step apparatus includes a front side, a back side, and opposed platform access sides. The front side is positioned next to a user selected bedside. A platform extends intermediate the front side, the back side, and the platform access sides. A platform support mechanism supports the platform in spaced relation relative to a reference surface and a target surface. At least one of the platform access sides provides access to the platform in a first direction so as to enable the user to stand thereupon in a user stance facing the first direction. The front side provides access to the target surface in a second direction orthogonal to the first direction. The platform enables the user to turn the user stance to face the second direction from the first direction.

### PRIOR HISTORY

This application claims the benefit of pending US Provisional Patent Application No. 63/653,302 filed in the United States Patent and Trademark Office on 30 May 2024, the specifications and drawings of which are hereby incorporated by reference thereto.

### FIELD OF THE INVENTION

The presently disclosed subject matter relates generally to an apparatus for enabling users to more easily access an elevated support structure by providing an intervening raised support platform upon which the user may step prior to accessing the elevated support structure. The presently disclosed subject matter more particularly relates to a bed step apparatus including rail-type supports for enabling a user to more easily access a bed or similar other support structures.

### DESCRIPTION OF PRIOR ART

Reference is made to a number of US patent disclosures authored by Vincent J. Baiera as developer of various step stools and methods of their use. In this regard, the reader is directed to International Patent Application Publication No. WO 2016/209646; U.S. Pat. No. 10,034,807; US Design Pat. No. D834,842; U.S. Pat. Nos. 10,213,353; 10,456,310; 10,835,432; 11,083,655; 11,311,437; US Patent Application Publication No. 2022/0241126; U.S. Pat. No. 11,850,197; and US Patent Application Publication No. 2024/0091086. The Baiera step stools all appear to assist a user into and out of structures having elevated elements.

These structures include bed structures and bathtub structures. Those disclosures believed to be most pertinent to the presently disclosed subject matter are the Baiera bed step stools, which include a first support configured to be disposed closer to the head of the bed; a second support configured to be disposed closer to the foot of the bed; and a step assembly supported between the first support and the second support. The step assembly enables the user to step thereon for assisting the user into and out of the bed. Add-on features include various mechanisms to essentially anchor the various step stools to the structures the user wishes to enter and exit.

More particularly, the bed step stool disclosures authored by Baiera all appear to be essentially limited to a step aid characterized by first and second supports that extend perpendicularly relative to a bed or tub side with at least one step portion extending therebetween to allow an unobstructed path perpendicular to the bed/tub side intermediate the first and second supports. In other words, the Baiera disclosures all appear to teach a stepping stool or step apparatus that enables a user to step upon a raised step toward a bedside. The raised step is laterally bound by first and second rail-type supports which may be grasped by the user as he or she enters the bed or tub in a direction perpendicular to the bedside.

Given that the prior art is replete with steps bound laterally by rail-type hand supports, typically of an even height, certain of the Baiera disclosures appear to be limited to the unique configuration of the first and second supports relative to one another (e.g. one is shorter than the other) so as to lend patentability thereto. It will be seen in some embodiments, for example, the first support enables the user to grasp by hand for supporting a first end of the user's body while the second support of a lesser height enables the user to lift a second end of the user's body thereover to gain entry to the bed. The perpendicular entry pathway relative to the Baiera bedside is left unobstructed thereby also enabling an exit from the bed therethrough. Notably, the step portions of the Baiera step stools are not configured to support a user's stance so as to enable a turning movement upon the user's stance prior to entry into the bed or tub, or after exit from the bed or tub.

The prior art perceives a need for a bed step apparatus having a front side, a back side, and laterally opposed platform access sides such that the front side abuts a select side of the bed, including any of a head side, a foot side, and laterally opposed bedsides. The prior art further perceive a need for a step apparatus having a back side that obstructs a perpendicular pathway to the bedside. In this regard, certain users may find a direct pathway to the bedside over relatively narrow treads difficult. In this regard, the prior art perceives a need for a bed step apparatus configured to provide a bed entry pathway having a first pathway portion extending in parallel relation to the select bedside and a second pathway portion extending perpendicularly to the select bedside as summarized in more detail hereinafter.

### GENERAL DESCRIPTIONS

The presently disclosed subject matter provides a step apparatus for beds and the like configured to provide a user platform configured for enabling a user to stand thereupon in a normal stance to face two directions and enable a stance turn before entering or after exiting the bed. In other words, the prior art does not appear to provide a step apparatus that allows a user to stand thereupon in a normal stance with ample room to reconfigure their person from a first direction to a second direction prior to entry to the bed or after exiting the bed.

The step apparatus according to the presently disclosed subject matter comprises spaced first and second hand rail type supports that together may define both a first plane parallel to a select bedside and an entryway to the select bedside and a third hand rail type support that defines a second plane parallel to the first plane in spaced relation relative thereto. The first and second planes define an entryway pathway that extends parallel to the select bedside and indirectly leads to the bed entryway perpendicular to the select bedside for enabling a user to firstly step upon a step support in a direction that is parallel to the select bedside and secondly turn to face the select bedside for entry thereto via the bed entryway defined by the first and second hand support rails.

The bed step apparatus according to the presently disclosed subject matter essentially provides a full body support platform adjacent a select bed side and not just a step tread adjacent the select bedside upon which platform the user may maneuver and/or turn standing with both feet apart in both a first plane and a second plane before entering the bed or after exiting the bed. There is provided in accordance with an embodiment of the presently disclosed subject matter a bed step apparatus for providing an elevated support surface intermediate a reference support surface and an upper bed surface.

The bed step apparatus according to the presently disclosed subject matter may be said to essentially comprise a bed-facing side, a back side opposite the bed-facing side, and opposed platform access sides extending intermediate the bed-facing side and the back side. The bed-facing side is positionable next to a select bedside. The bed step apparatus further comprises a platform extending intermediate the bed-facing side, the back side, and the opposed platform access sides, which platform extends in a platform plane. A platform support mechanism supports the platform in spaced relation relative to the reference surface and the upper bed surface.

At least one of the platform access sides is configured to provide access to the platform in a first direction so as to enable the user to stand thereupon in a user stance facing the first direction. The bed-facing side is configured to provide access to the upper bed surface in a second direction orthogonal to the first direction. The platform is configured to enable the user to turn the user stance to face the second direction from the first direction.

In some embodiments, the bed-facing side comprises a first hand support rail and a second hand support rail spaced from the first hand support rail. The first and second hand support rails are configured to provide access to the upper bed surface through at least one open configuration. In some embodiments, the first and second hand support rails are alignable in a first hand rail support plane. In some embodiments, the back side comprises a third hand support rail. The third hand support rail extends in a second hand support plane parallel to the first hand support plane. The first and second hand support planes define an apparatus access pathway extending at least along the first direction.

In some embodiments, at least one of the first and second hand support rails are pivotal about a support axis of rotation. In some embodiments, at least one of the first, second and third hand support rails are vertically adjustable for adjusting a height thereof relative to the reference surface and the upper bed surface. In some embodiments, at least one of the first and second hand support rails comprise an upper hand support portion and a lower hand support portion. In some embodiments, the upper and lower hand support portions together provide a bifurcated gate when aligned in the first hand support plane and pivoted to a closed configuration for preventing the user from entering a space above the platform from the upper bed surface.

In some embodiments, at least one of the first hand support rail and a second hand support rail comprises an apparatus anchor assembly. The apparatus anchor assembly is positionable intermediate an upper bed structure and a lower bed structure such that a weight of the upper bed structure is directed downwardly for securing the apparatus anchor assembly intermediate the upper and lower bed structures. In some embodiments, the platform support mechanism is vertically adjustable for adjusting a distance of the platform relative to at least the reference surface. In some embodiments, the user stance comprises a stance distance and the platform comprising a platform length and a platform width. Each of the platform length and the platform width are greater than the stance distance of a normal user stance. In some embodiments, the platform length equals the platform width.

There is provided in accordance with another embodiment of the presently disclosed subject matter a step apparatus for providing an elevated support surface intermediate a reference support surface and a target support surface. The step apparatus comprises a front side, a back side, and laterally opposed platform access sides. The front side is positionable adjacent the target support surface. The step apparatus further comprises a platform extending intermediate the front side, the back side, and the laterally opposed platform access sides. A platform support mechanism supports the platform in spaced relation relative to the reference surface and the target support surface.

At least one of the platform access sides is configured to provide access to the platform in a first direction so as to enable the user to stand thereupon in a user stance facing the first direction. The front side is configured to provide access to the target support surface in a second direction orthogonal to the first direction. The platform is configured to enable the user to turn the user stance to face the second direction from the first direction.

In some embodiments, the front side comprises a first support rail and a second support rail spaced from the first support rail configured to provide access to the target support surface when in an open configuration. In some embodiments, the first and second support rails are pivotal about a support axis of rotation and alignable in a first rail support plane to effect either the open configuration or a closed configuration. In some embodiments, the back side comprises a third support rail. The third support rail extends in a second support plane parallel to the first support plane. The first and second support planes define an apparatus access pathway extending at least along the first direction.

In some embodiments, at least one of the first, second and third support rails are vertically adjustable for adjusting a height thereof relative to the reference surface and the target support surface. In some embodiments, at least one of the first and second support rails comprises an upper support portion and a lower support portion. In some embodiments, the upper and lower support portions provide together provide a bifurcated gate when aligned in the first support plane in the closed configuration for preventing the user from entering a space above the platform from the target support surface.

In some embodiments, the platform support mechanism is adjustable for adjusting a distance of the platform relative to at least the reference support surface. In some embodiments, wherein at least one of the first hand support rail and a second hand support rail comprises an apparatus anchor assembly, which apparatus anchor assembly being positionable intermediate an upper structure and a lower structure. A weight of the upper structure secures the apparatus anchor assembly intermediate the upper and lower structures. In some embodiments, the user stance comprises a stance distance, and the platform comprises a platform length and a platform width. Each of the platform length and the platform width are greater than the stance distance. In some embodiments, the platform length equals the platform width.

### BRIEF DESCRIPTION OF THE DRAWINGS

Other features and objectives of the presently disclosed subject matter will become more evident from a consideration of the following brief descriptions of patent drawings.

FIG. 1 is a front perspective view of a first step apparatus according to the presently disclosed subject matter showing the first step apparatus in a first open configuration.

FIG. 2 is an exploded perspective view of the first step apparatus according to the presently disclosed subject matter showing hand support rails at the bed-facing side of the first step apparatus in the first open configuration.

FIG. 2A is an enlarged exploded view of a support post and a post foot showing an array of upper pin-receiving apertures and an array of lower pin-receiving apertures extending orthogonally relative to the upper pin-receiving apertures.

FIG. 3 is a first lateral side elevational view of the first step apparatus according to the presently disclosed subject matter supported upon a reference support surface and a platform of the first step apparatus extending in parallel raised relation relative to the reference support surface and showing a first direction directed into the page and a second direction directed to the right of the page away from the bed-facing side.

FIG. 3A is a reduced lateral side elevational view of the first step apparatus otherwise shown in FIG. 3 depicting the first step apparatus positioned next to a first bedside of a generic bed according to the presently disclosed subject matter.

FIG. 4 is a second lateral side elevational view of the first step apparatus according to the presently disclosed subject matter supported upon the reference support surface and the platform of the first step apparatus extending in parallel raised relation relative to the reference support surface and showing a first direction directed into the page and the second direction directed to the left of the page away from the bed-facing side.

FIG. 4A is a reduced lateral side elevational view of the first step apparatus otherwise shown in FIG. 4 depicting the first step apparatus positioned next to a second bedside of the generic bed according to the presently disclosed subject matter.

FIG. 5 is a front side elevational view of the first step apparatus according to the presently disclosed subject matter supported upon the reference support surface and the platform of the first step apparatus extending in parallel relation intermediate the reference support surface and an upper bed surface depicted in broken lines and showing the first step apparatus in the first open configuration and showing the first directions directed toward one another from either of opposed platform access sides and the second direction directed out of the page away from a bed-facing side.

FIG. 6 is a back side elevational view of the first step apparatus according to the presently disclosed subject matter supported upon the reference support surface and the platform of the first step apparatus extending in parallel relation intermediate the reference support surface and the upper bed surface depicted in broken lines and showing the first step apparatus in the first open configuration and showing the first directions directed toward one another from either of the platform access sides and the second direction directed into the page away from the bed-facing side.

FIG. 7 is a top plan view of the first step apparatus according to the presently disclosed subject matter showing the first step apparatus in the first open configuration and a main apparatus plane in broken lines separating the first step apparatus into symmetrical lateral halves and showing the first directions directed toward one another from either of the platform access sides and the second direction directed to the left of the page away from the bed-facing side.

FIG. 8 is a bottom plan view of the first step apparatus according to the presently disclosed subject matter showing the apparatus in the first open configuration and showing the first directions directed toward one another from either of the platform access sides and the second direction directed to the left of the page away from the bed-facing side.

FIG. 9A is a top plan view of the first step apparatus according to the presently disclosed subject matter shown in the first open configuration and positioned next to a right bedside of a generic bed and showing the first directions directed toward one another from either of the platform access sides and the second direction directed to the left of the page away from the bed-facing side toward the upper bed surface.

FIG. 9B is a top plan view of the first step apparatus according to the presently disclosed subject matter shown in the first open configuration and positioned next to a left bedside of a generic bed and showing the first directions directed toward one another from either of the platform access sides and the second direction directed to the right of the page away from the bed-facing side toward the upper bed surface.

FIG. 9C is a top plan view of the first step apparatus according to the presently disclosed subject matter shown in the first open configuration and positioned next to a foot end of a generic bed and showing the first directions directed toward one another from either of the platform access sides and the second direction directed to the top of the page away from the bed-facing side toward the upper bed surface.

FIG. 9D is a top plan view of the first step apparatus according to the presently disclosed subject matter shown in the first open configuration and positioned next to a head end of a generic bed and showing the first directions directed toward one another from either of the platform access sides and the second direction directed to the bottom of the page away from the bed-facing side toward the upper bed surface.

FIG. 10 is a top plan view of the first step apparatus according to the presently disclosed subject matter showing the first step apparatus in a second open configuration wherein a first hand support rail is pivoted 90 degrees relative to a first hand rail support plane and depicting opposed platform entry ways directed toward one another and a bed entry way directed to the left of the page through the bed-facing side.

FIG. 10A is a reduced top plan view of the first step apparatus otherwise shown in FIG. 10 depicting the first step apparatus positioned next to a right bedside of the generic bed and depicting the opposed platform entry ways directed toward one another and the bed entry way directed to the left of the page through the bed-facing side toward the upper bed surface.

FIG. 11 is a top plan view of the first step apparatus according to the presently disclosed subject matter showing the first step apparatus in a third open configuration wherein both the first hand support rail and a second hand support rail are pivoted 90 degrees relative to the first hand rail support plane and depicting opposed platform entry ways directed toward one another and a bed entry way directed to the left of the page through the bed-facing side.

FIG. 11A is a reduced top plan view of the first step apparatus otherwise shown in FIG. 11 depicting the first step apparatus positioned next to a right bedside of the generic bed and depicting the opposed platform entry ways directed toward one another and the bed entry way directed to the left of the page through the bed-facing side toward the upper bed surface.

FIG. 12 is a top plan view of the first step apparatus according to the presently disclosed subject matter showing the first step apparatus in a closed configuration wherein both the first hand support rail and the second hand support rail are pivoted toward one another to extend within the first hand rail support plane and depicting a platform entry way directed toward the bottom of the page and a closed bed entry way at the bed-facing side.

FIG. 12A is a reduced top plan view of the first step apparatus otherwise shown in FIG. 12 depicting the first step apparatus positioned next to a right bedside of the generic bed and depicting opposed platform entry ways directed toward one another and a closed bed entry way at the bed-facing side.

FIG. 12B is a front side elevational view of the first step apparatus according to the presently disclosed subject matter supported upon the reference support surface and the platform of the first step apparatus extending in parallel relation intermediate the reference support surface and the upper bed surface depicted in broken lines and showing the first step apparatus in the closed configuration.

FIG. 12C is a back side elevational view of the first step apparatus according to the presently disclosed subject matter supported upon the reference support surface and the platform of the first step apparatus extending in parallel relation intermediate the reference support surface and the upper bed surface depicted in broken lines and showing the first step apparatus in the closed configuration.

FIG. 13A is a first sequential top plan view of the first step apparatus according to the presently disclosed subject matter showing the first step apparatus in the first open configuration and a user stance represented by footprints upon the platform entering the first step apparatus through a platform entry way and facing a first direction parallel to a bed-facing side and a back side of the first step apparatus.

FIG. 13B is a second sequential top plan view of the first step apparatus according to the presently disclosed subject matter showing the first step apparatus in the first open configuration and the user stance represented by footprints upon the platform turned 90 degrees to face a bed entry way along a second direction orthogonal to the bed-facing side and the back side of the first step apparatus.

FIG. 13C is a third sequential top plan view of the first step apparatus according to the presently disclosed subject matter showing the first step apparatus in the first open configuration and the user stance represented by footprints upon the platform entering the first step apparatus through the bed entry way and facing a direction opposite the second direction orthogonal to the bed-facing side and the back side of the first step apparatus.

FIG. 13D is a fourth sequential top plan view of the first step apparatus according to the presently disclosed subject matter showing the first step apparatus in the first open configuration and the user stance represented by footprints upon the platform exiting the first step apparatus through the platform entry way and facing a direction opposite the first direction parallel to the bed-facing side and the back side of the first step apparatus.

FIG. 14 is an exploded perspective view of a platform-supporting pin mechanism disposed intermediate an upper collar cap and a lower collar cap according to the presently disclosed subject matter.

FIG. 15 is a bottom perspective view of a corner of the first step apparatus according to the presently disclosed subject matter showing the platform-supporting pin mechanism engaged with a post support collar to space the platform along a length of a support post, the upper and lower collar caps capping upper and lower ends of the post support collar.

FIG. 16 is an exploded perspective view of a lower end of an upright member of a back side support rail positioned adjacent a post cap and a spring-biasable pin element according to the presently disclosed subject matter.

FIG. 17 is a fragmentary perspective view of a lower end of an upright member of a back side support rail telescopically mated with an upper end of a support post such that a spring-biasable pin element is received in a pin-receiving aperture of the upper end of the support post for fixing an exposed length of the upright member relative the support post.

FIG. 18 is an enlarged elevational view of a front side post showing a spring-biasable pin element at a lower end thereof and circumferentially spaced pin receiving apertures at an upper end thereof.

FIG. 19 is an enlarged fragmentary perspective view of a lower post end of a hand support rail showing a spring-biasable pin element.

FIG. 20 is a perspective view of a hand support rail according to the presently disclosed subject matter showing an upper hand support portion, a lower hand support portion, a connecting portion and a post element, the lower end of the post element comprising the spring-biasable pin element.

FIG. 21 is a front perspective of a second step apparatus according to the presently disclosed subject matter showing a handrail-anchor assembly at the bed-facing side at a first platform access side and a relatively short placeholder post at the at the bed-facing side at a second platform access side.

FIG. 22 is a top plan view of the second step apparatus according to the presently disclosed subject matter showing the handrail-anchor assembly at the bed-facing side at the first platform access side and depicting a platform entry way directed toward the bottom of the page and the bed entry way directed to the left of the page through the bed-facing side.

FIG. 23 is a bottom plan view of the second step apparatus according to the presently disclosed subject matter showing the handrail-anchor assembly at the bed-facing side at the first platform access side and depicting a platform entry way directed toward the top of the page and the bed entry way directed to the right of the page through the bed-facing side.

FIG. 24 is a first sequential first platform access side view of the second step apparatus according to the presently disclosed subject matter showing an apparatus anchor assembly of the second step apparatus positioned intermediate a mattress and a box spring with the mattress being directed downwardly atop the apparatus anchor assembly and showing a first direction directed into the page and a second direction directed to the right of the page away from the bed-facing side.

FIG. 24A is a second sequential first platform access side view of the second step apparatus according to the presently disclosed subject matter showing the apparatus anchor assembly of the second step apparatus anchored intermediate the mattress and the box spring with a mattress weight pressing the apparatus anchor assembly to anchor the second step apparatus anchored intermediate the mattress and the box spring and showing the first direction directed into the page and the second direction directed to the right of the page away from the bed-facing side.

FIG. 25 is a second platform access side view of the second step apparatus according to the presently disclosed subject matter showing the apparatus anchor assembly of the second step apparatus positioned intermediate the mattress and the box spring with the mattress being directed downwardly atop the apparatus anchor assembly and showing the first direction directed out of the page and the second direction directed to the left of the page away from the bed-facing side.

FIG. 26 is a front elevational view of the second step apparatus according to the presently disclosed subject matter showing the apparatus anchor assembly positioned at the first platform access side of the second step apparatus and the relatively short placeholder post positioned at the second platform access side of the second step apparatus and showing the first direction directed to the right of the page and the second direction directed out of the page away from the bed-facing side.

FIG. 27 is a rear elevational view of the second step apparatus according to the presently disclosed subject matter showing the apparatus anchor assembly positioned at the first platform access side of the second step apparatus and showing the first direction directed to the left of the page and the second direction directed into the page away from the bed-facing side.

FIG. 28A is a front elevational view of the second step apparatus according to the presently disclosed subject matter showing the apparatus anchor assembly positioned at the first platform access side of the second step apparatus and a hand support rail positioned at the second platform access side of the second step apparatus rotated into a first open configuration and showing the first direction directed to the right of the page and the second direction directed out of the page away from the bed-facing side.

FIG. 28B is a front elevational view of the second step apparatus according to the presently disclosed subject matter showing the apparatus anchor assembly positioned at the second platform access side of the second step apparatus and a hand support rail at the first platform access side of the second step apparatus rotated into the first open configuration and showing the first direction directed to the left of the page and the second direction directed out of the page away from the bed-facing side.

FIG. 29 is a first sequential top plan view of the second step apparatus according to the presently disclosed subject matter showing the apparatus anchor assembly positioned at the first platform access side of the second step apparatus and a hand support rail positioned at the second platform access side of the second step apparatus rotated into a first open configuration and showing the first direction directed to the bottom of the page and the second direction directed to the left of the page away from the bed-facing side.

FIG. 30 is a second sequential top plan view of the second step apparatus according to the presently disclosed subject matter showing the apparatus anchor assembly positioned at the first platform access side of the second step apparatus and the hand support rail positioned at the second platform access side of the second step apparatus rotated into a second open configuration and showing the first direction directed to the bottom of the page and the second direction directed to the left of the page away from the bed-facing side.

FIG. 31 is a third sequential top plan view of the second step apparatus according to the presently disclosed subject matter showing the apparatus anchor assembly positioned at the first platform access side of the second step apparatus and the hand support rail positioned at the second lateral side of the second step apparatus rotated into a closed configuration and depicting a minimized bed entry way.

FIG. 32 is a top plan view of the second step apparatus according to the presently disclosed subject matter showing the apparatus anchor assembly positioned at the first platform access side of the second step apparatus and a relatively longer hand support rail positioned at the second platform access side of the second step apparatus rotated into the closed configuration and depicting a minimized bed entry way.

### DETAILED DESCRIPTION OF THE EMBODIMENTS

Referring now to the drawings with more specificity, the presently disclosed subject matter concerns a first step apparatus 10 and a second step apparatus 210 for enabling a user to elevate oneself upon an elevated support surface prior to entry into or onto a structure having an elevated feature relative to a reference support surface 100 as exemplified by a floor or ground surface. In this regard, it is noted that some users, such as those with limited ambulatory abilities, often find it difficult to access or traverse such elevated features without the aid of a step or series of steps. Steps generally help the user more easily and gradually elevate oneself so as to access or traverse these elevated features. Reference is made by way of example to a stairway in the famous Winchester house in San Jose, California comprising forty-four steps with a total rise of only ten feet then specifically constructed to help the ailing Ms. Winchester access areas at either end of the stairway. The purpose of steps as riser means and the like is generally well understood in the art as exemplified in part by the Baiera disclosures introduced above.

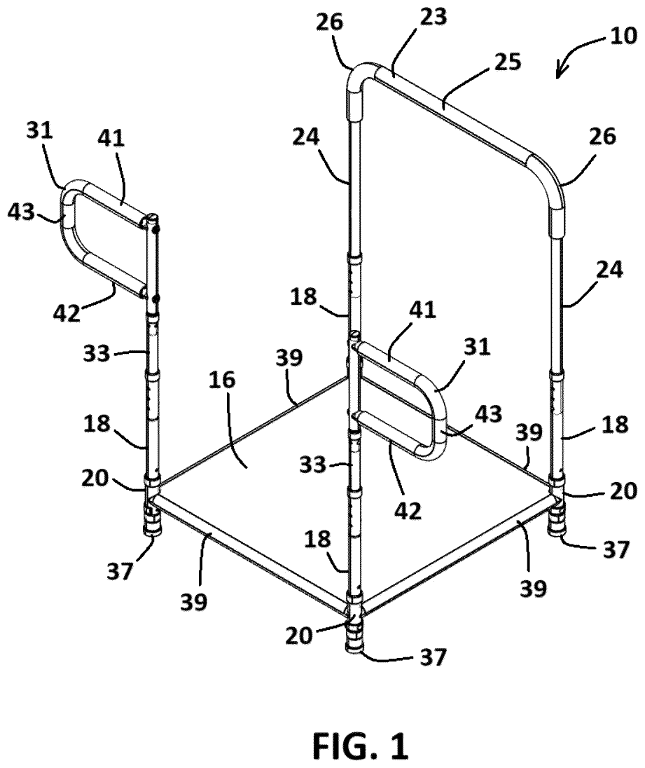

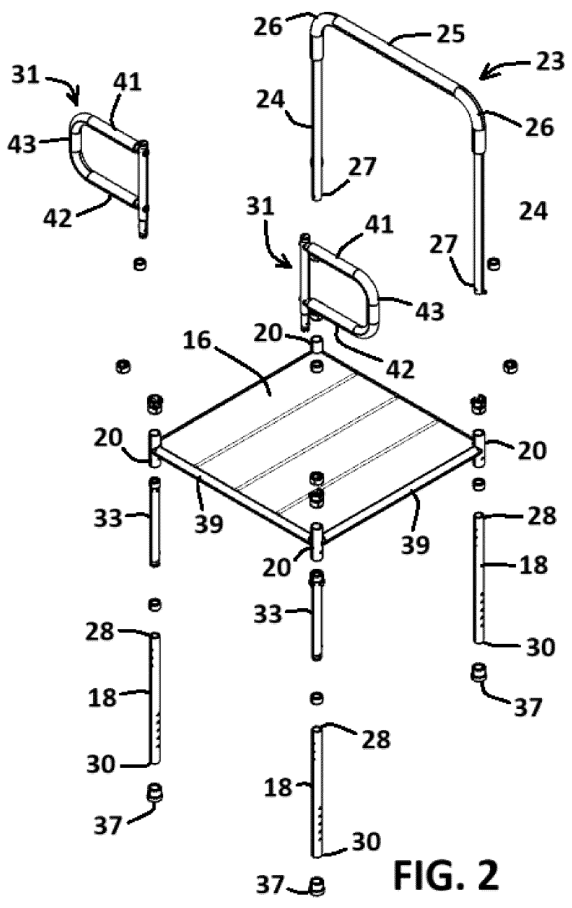

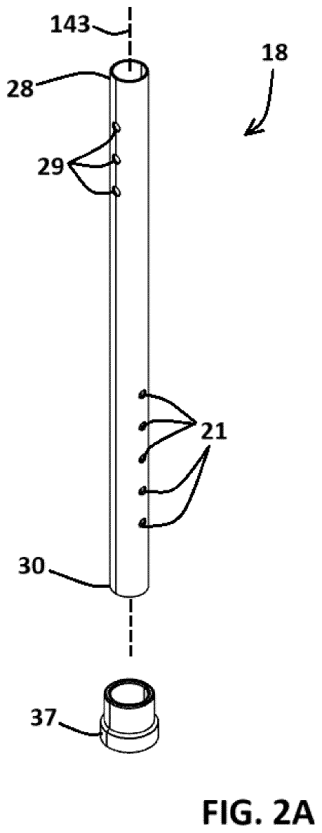

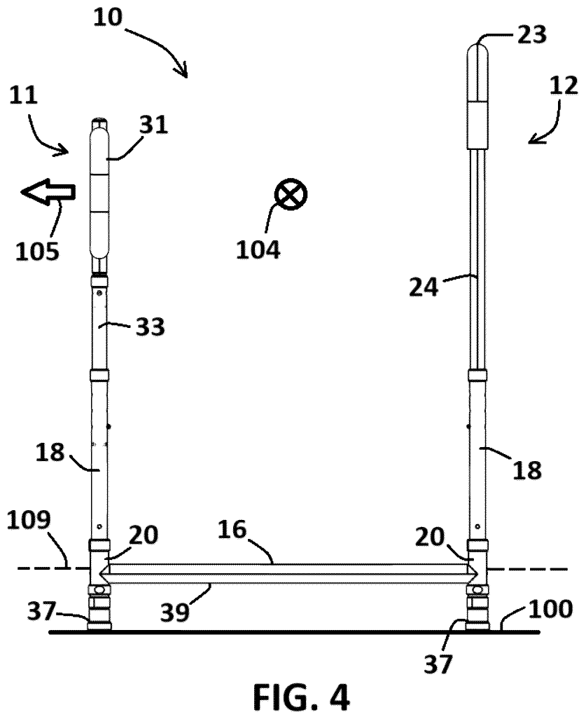

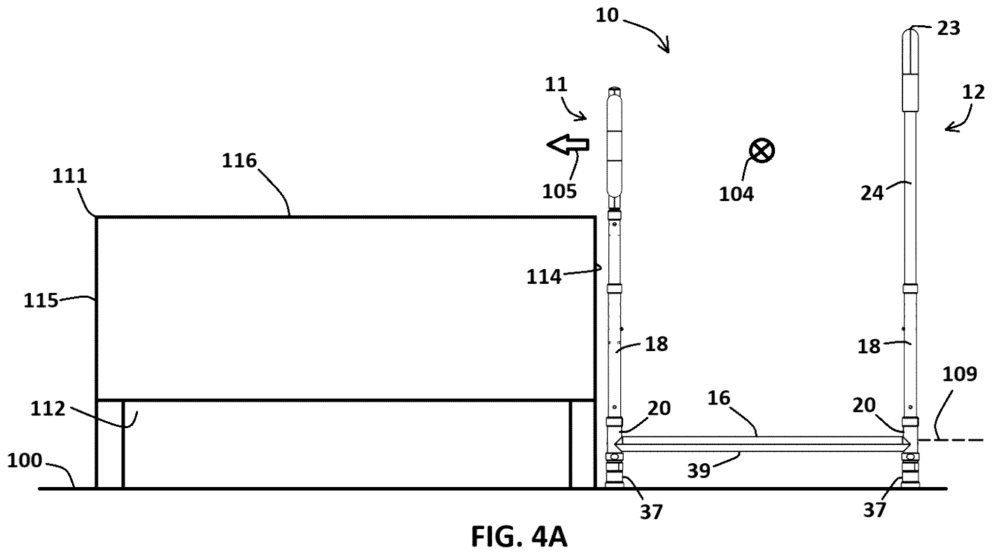

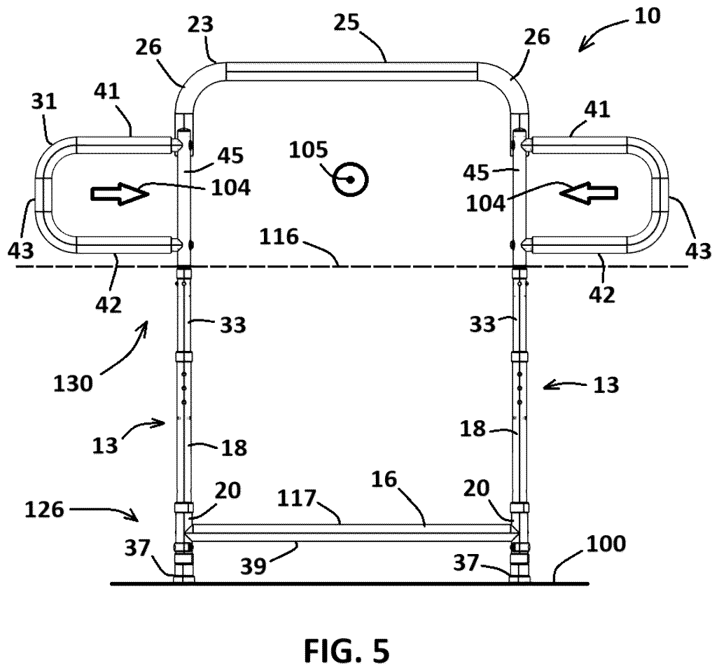

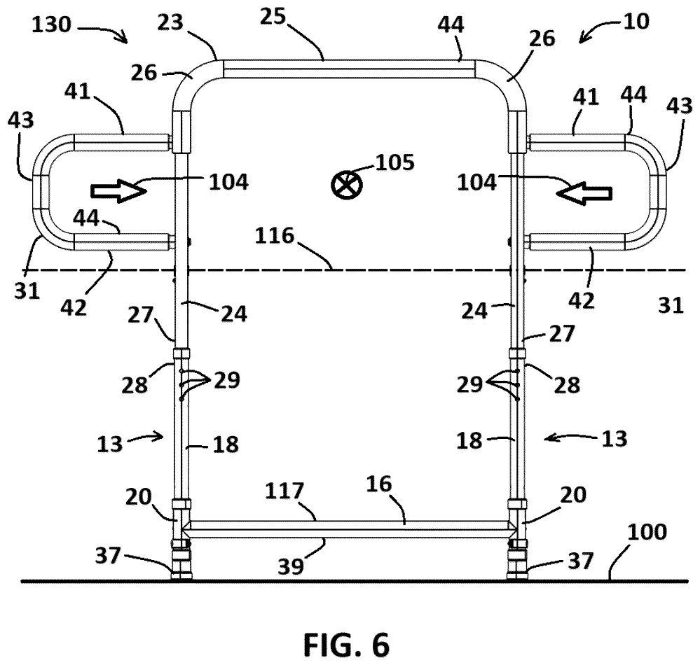

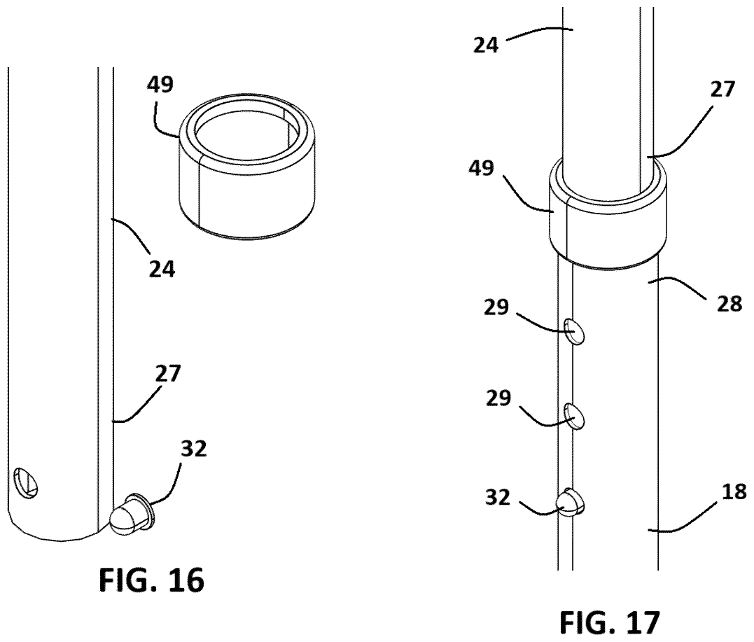

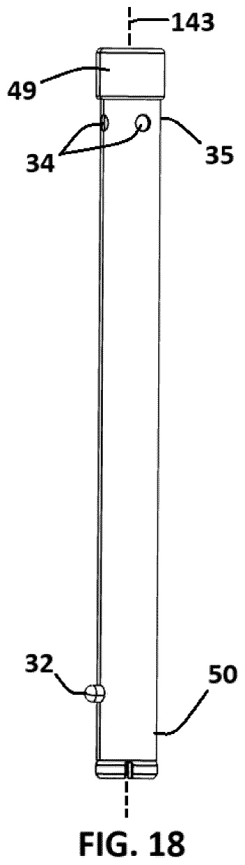

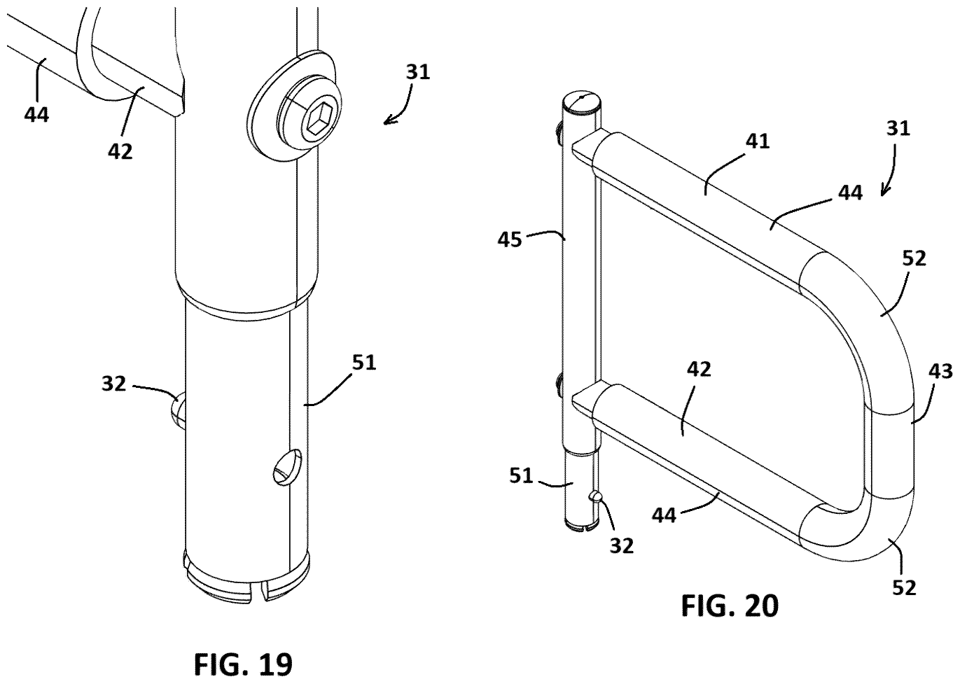

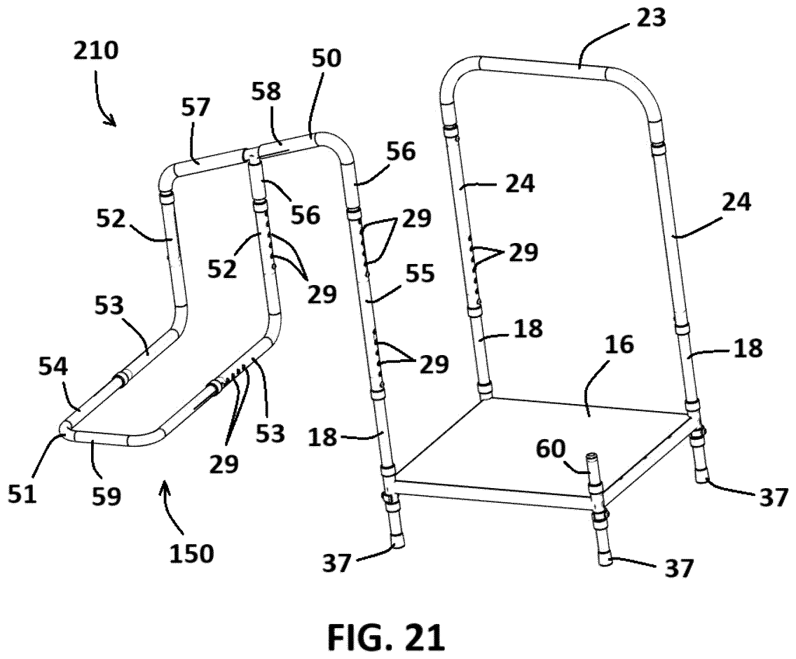

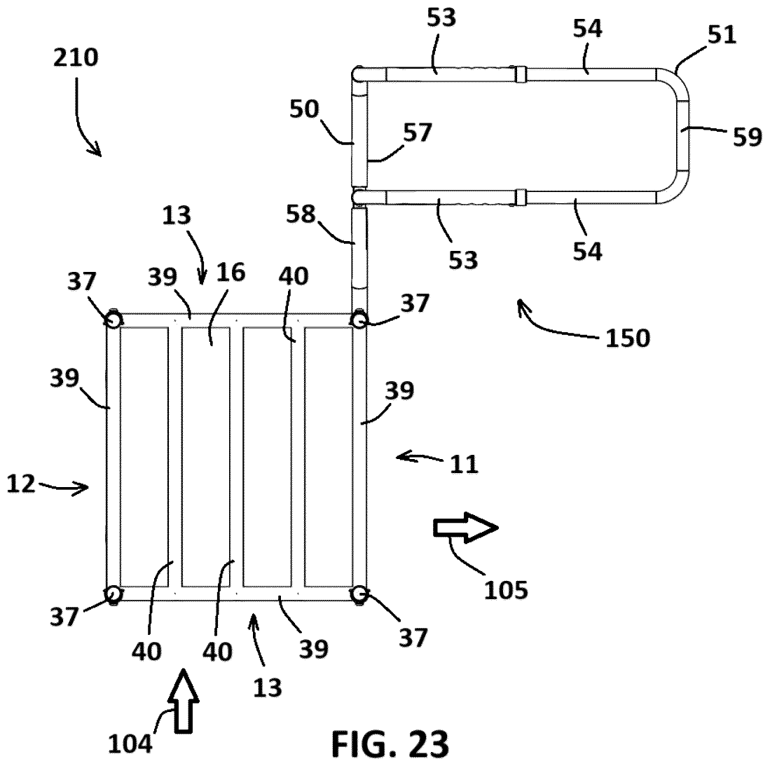

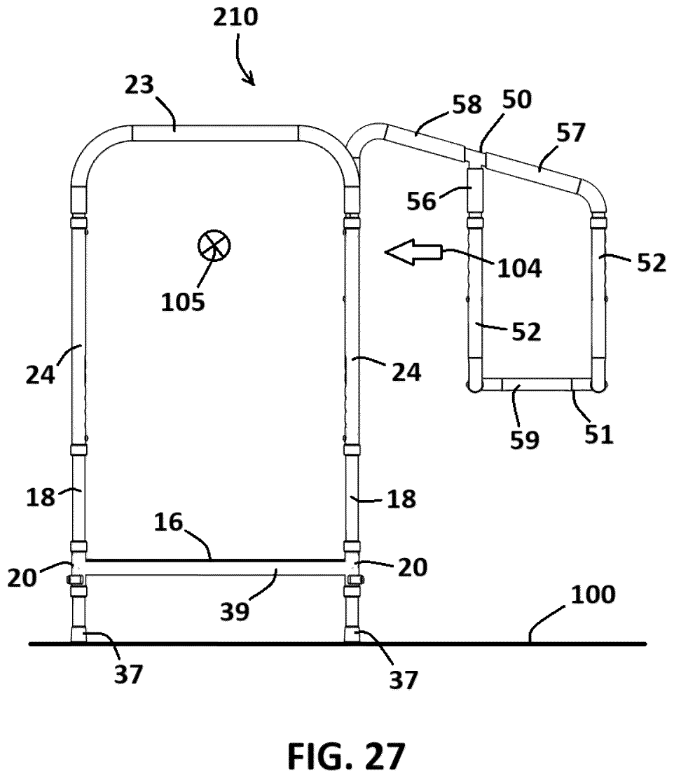

In some embodiments, the first step apparatus 10 and a second bed step apparatus 210 according to the presently disclosed subject matter are each configured to enable a user to enter and exit a bed 111 as supported by the reference support surface 100 and in these embodiments may be referred to as a first bed step apparatus 10 and a second bed step apparatus 210. The first bed step apparatus 10 according to the presently disclosed subject matter is generally depicted in FIGS. 1-20 and the second bed step apparatus 210 according to the presently disclosed subject matter is generally depicted in FIGS. 21-32. For ease of description, the first bed step apparatus 10 depicted in FIGS. 1-20 is firstly described in detail below and the second bed step apparatus 210 depicted in FIGS. 21-32 is described in detail following descriptions directed to the first bed step apparatus 10 for ease of understanding.

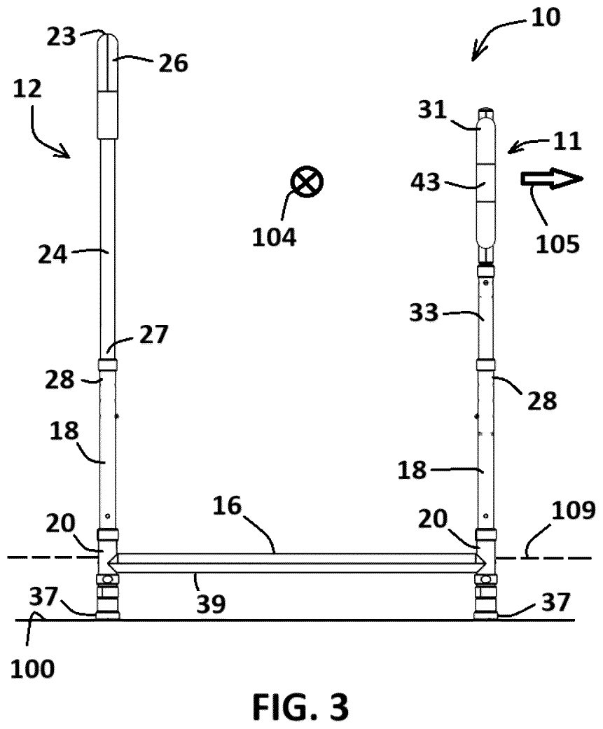

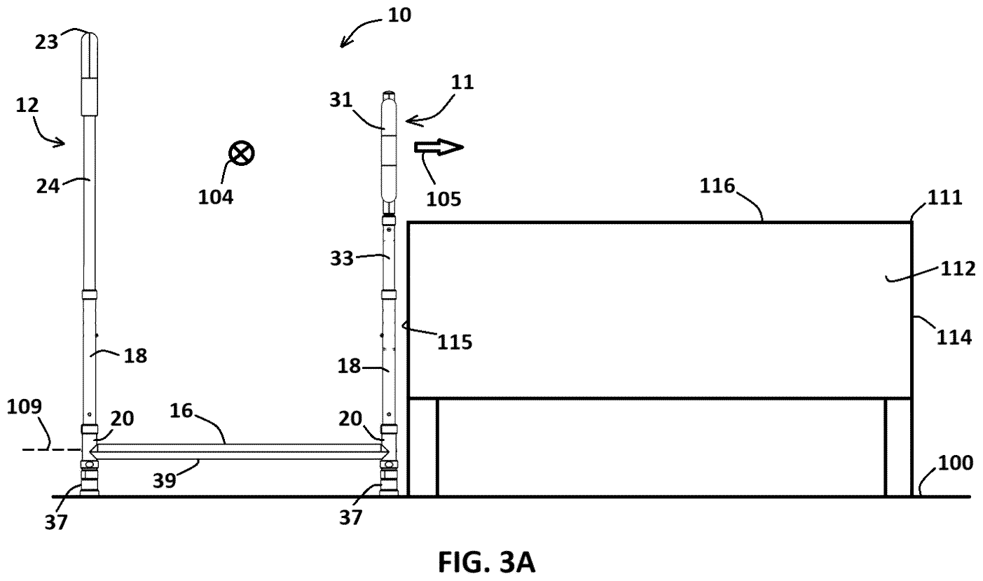

A generic bed is depicted with a box-like structure and introduced and referenced at 111 in FIGS. 3A, 4A and 9A-9D. The bed 111 essentially comprises a head end 112, a foot end 113, a left bedside 114, a right bedside 115 and an upper bed surface 116, which upper bed surface 116 defines the elevated feature in some applications. Should the first step apparatus 10 or the second step apparatus 210 be used to alternatively help users enter or exit a bathtub, for example, the elevated feature may be defined by the tops of either of the sidewalls of the bathtub. The first step apparatus 10 and the second step apparatus 210 are configured to raise the user relative to the top of either of the sidewalls of the bathtub to traverse the same and gain entry to the bathtub.

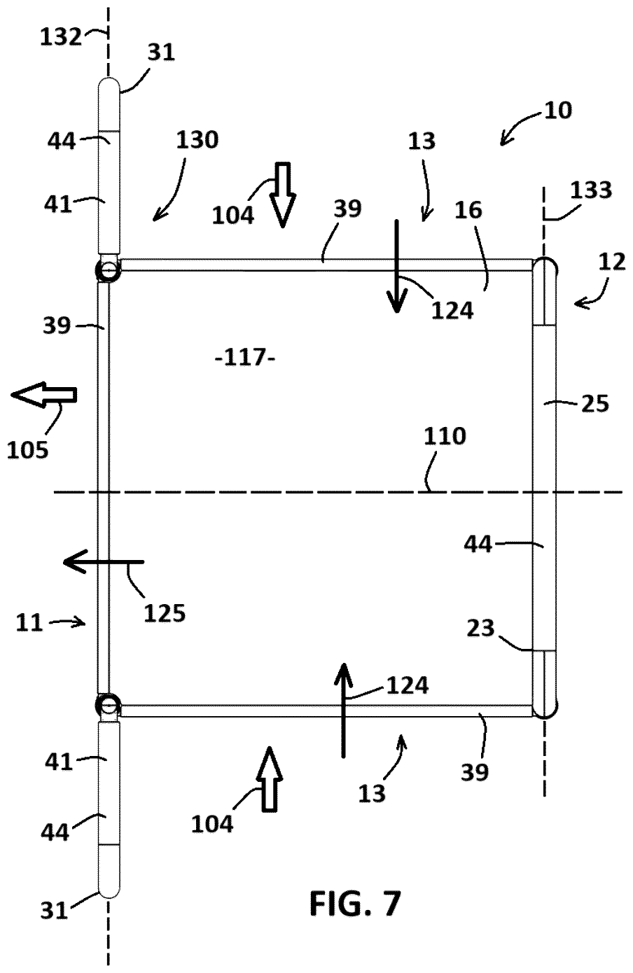

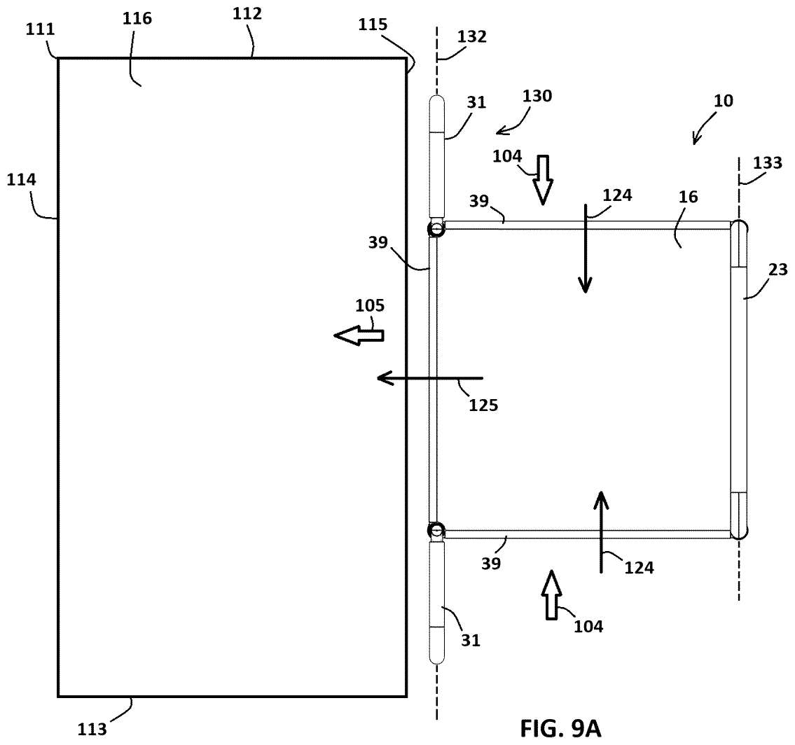

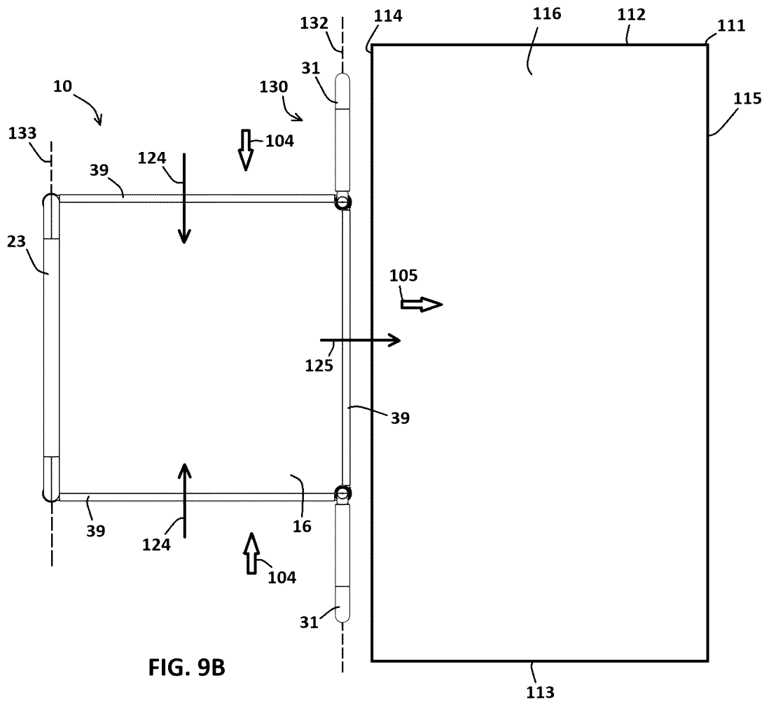

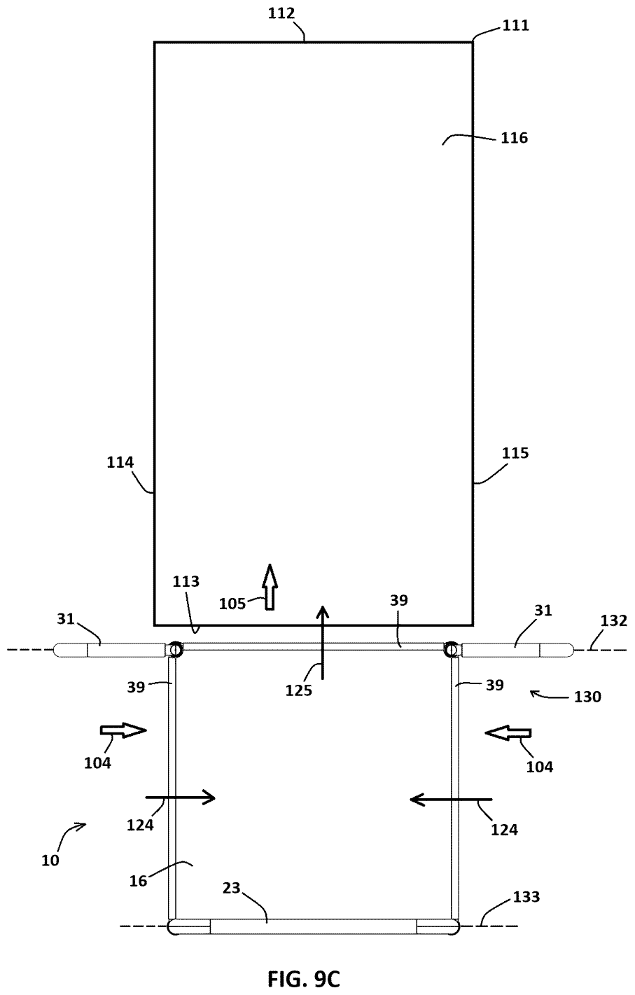

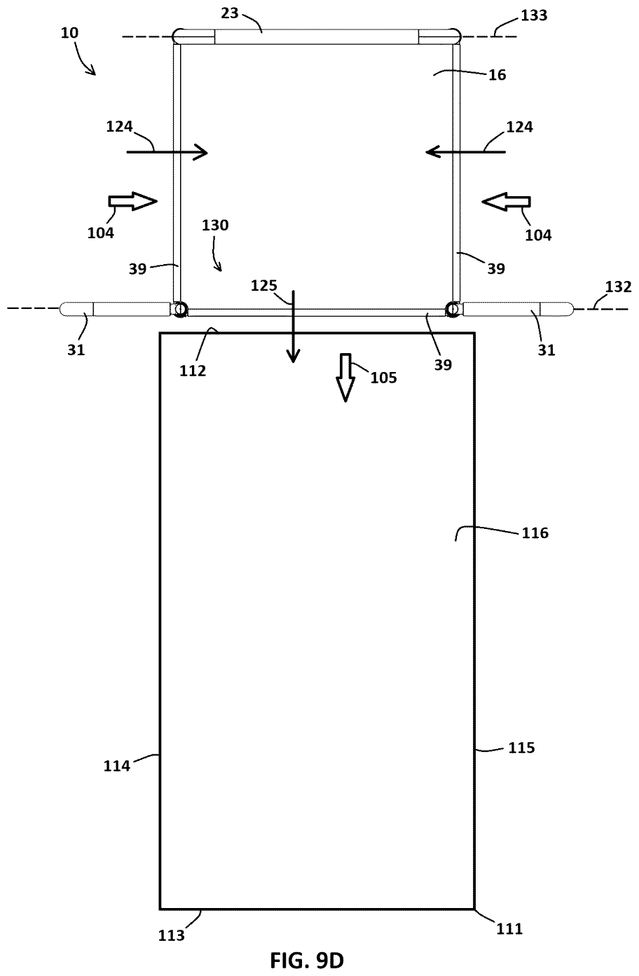

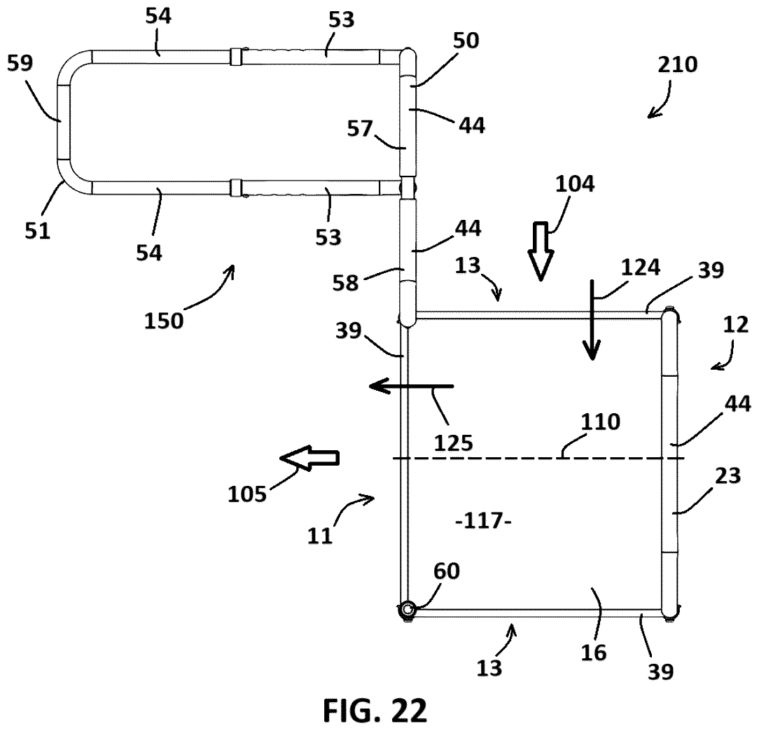

When used as a step apparatus for entry into or onto a bed 111, the first bed step apparatus 10 according to the presently disclosed subject matter is configured to be positioned at any one of the head end or side 112, the foot end or side 113, the left bedside 114 or the right bedside 115 as the user may prefer or as dependent on the bedroom layout. In this regard, the first bed step apparatus 10 according to the presently disclosed subject matter is generally symmetrical about a main apparatus plane 110 separating a first platform access side 13 from a second platform access side 13 in some embodiments as generally depicted and referenced in FIG. 7. Given its symmetry about the main apparatus plane 110, the bed step apparatus 10 does not necessarily have a head end or foot end. The bed step apparatus 10 may be positioned next to any of the bed sides 112, 113, 114 or 115 as comparatively depicted in FIGS. 9A through 9D. In some embodiments, the second bed step apparatus 210 is asymmetrical about the main apparatus plane 110 as generally depicted and referenced in FIG. 22 and accordingly is preferably positionable at either of the left bedside 114 or the right bedside 115 or next to a longer dimension of the bed 111.

In some embodiments, the bed step apparatus 10 is four-sided and necessarily comprises a front or bed-facing side 11, a back side 12 and laterally opposed platform access sides 13. The front or bed-facing side 11 is configured to oppose or face a select bed side as selected from the group consisting of the head end or side 112, the foot end or side 113, the left bedside 114 and the right bedside 115 as comparatively depicted in FIGS. 9A-9D. The bed-facing side 11 of the bed step apparatus 10 provides a bed entry way 125 to and from the upper bed surface 116 at the select bedside when the bed-facing side 11 is positioned in adjacency thereto. In some applications, the bed step apparatus 10 may be utilized for gaining access to other target support surfaces such as a table top or countertop or for traversing upper portions of a bathtub as introduced above.

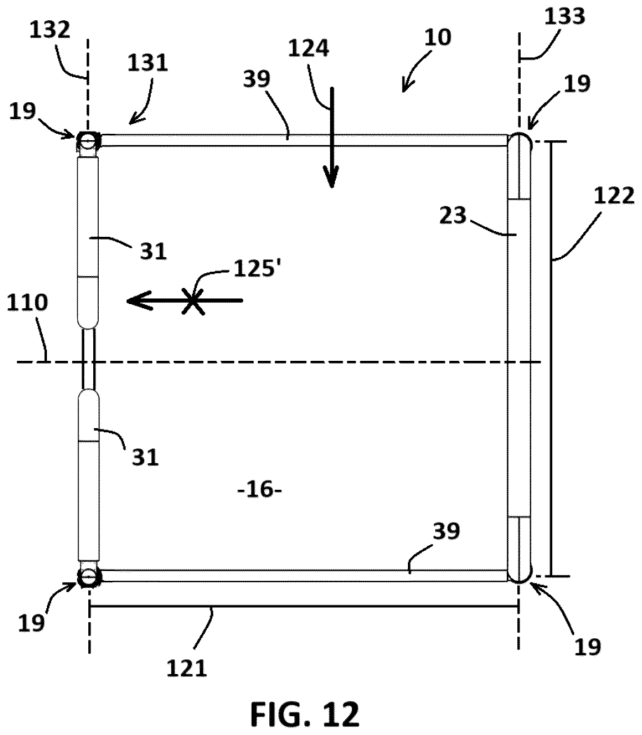

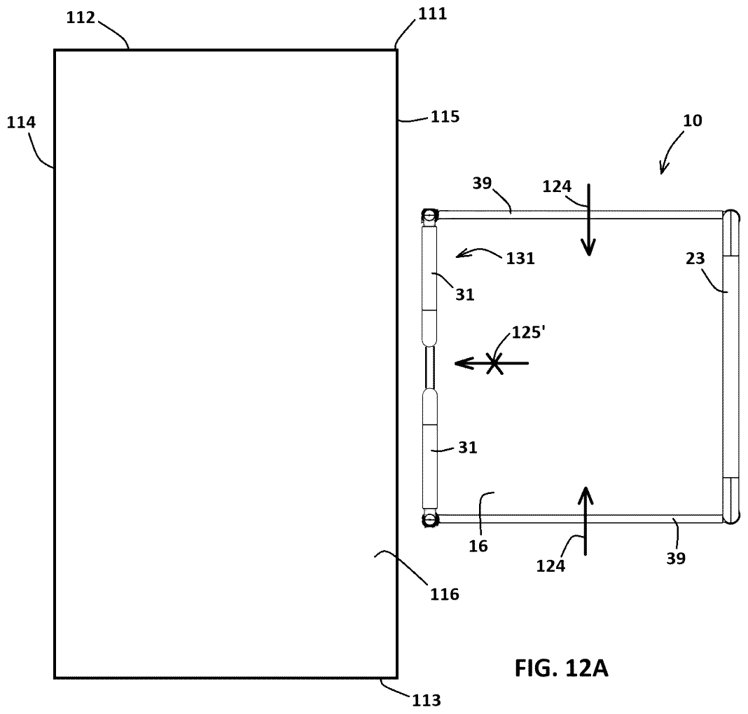

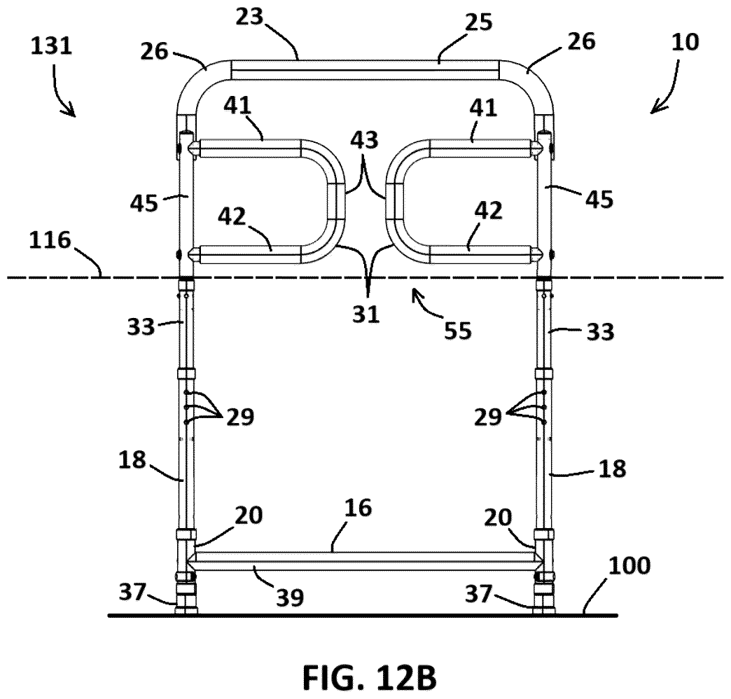

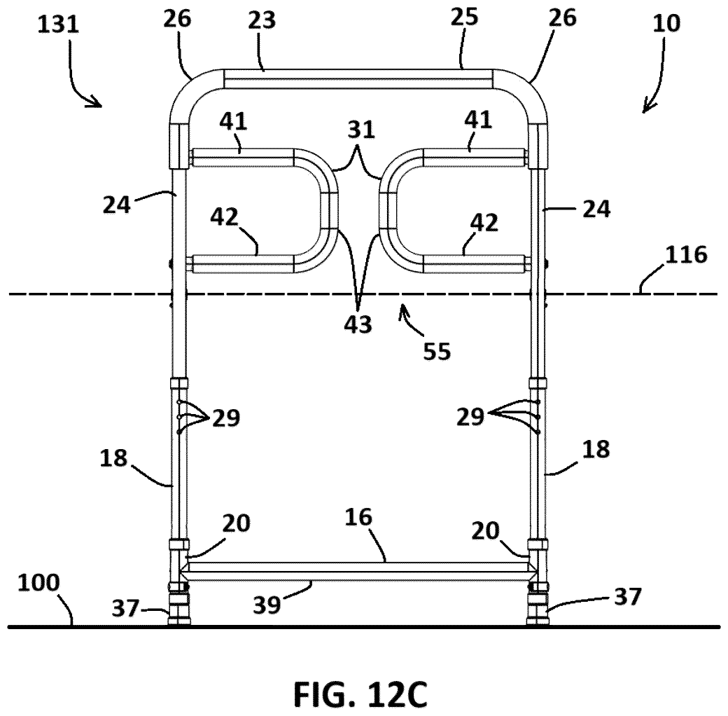

The bed-facing side 11 is reconfigurable intermediate an open apparatus configuration 130 generally referenced in FIGS. 9A-11A and a closed apparatus configuration 131 as particularly referenced in FIGS. 12-12C. The bed entry way 125 is provided when the bed-facing side 11 is in any of the open apparatus configurations 130. Notably, the open apparatus configuration 130 has been illustrated as including a number of open configurations. A first, a second, and a third open configuration are comparatively depicted in FIGS. 9A through 11A. Hand support rails 31 of the bed step apparatus 10 may be independently pivoted about support axes of rotation 143 in any of the open configuration(s) 130 as the user may elect. The closed apparatus configuration 131 prevents bodily movement through the otherwise open bed entry way 125 in order to, for example, provide a gate mechanism to help prevent the user from inadvertently exiting the select bedside during the night or while sleeping.

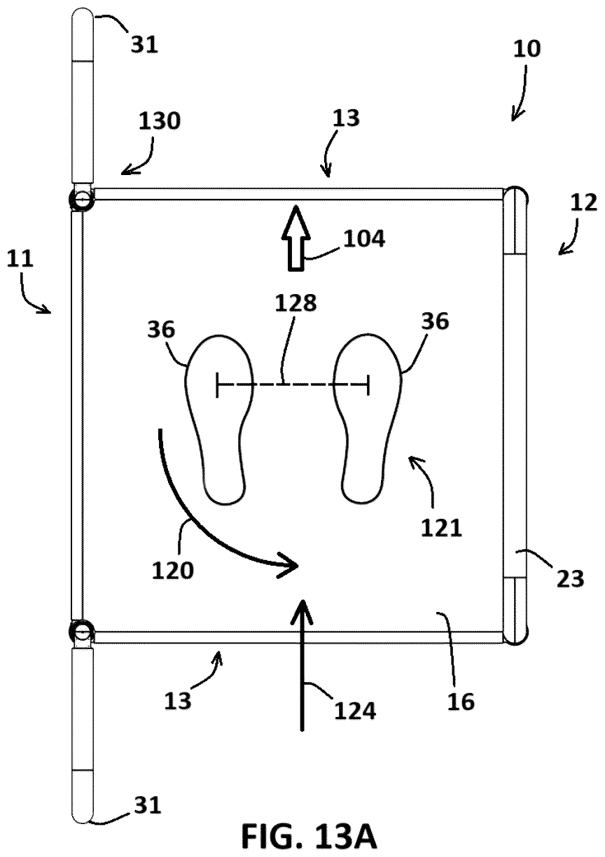

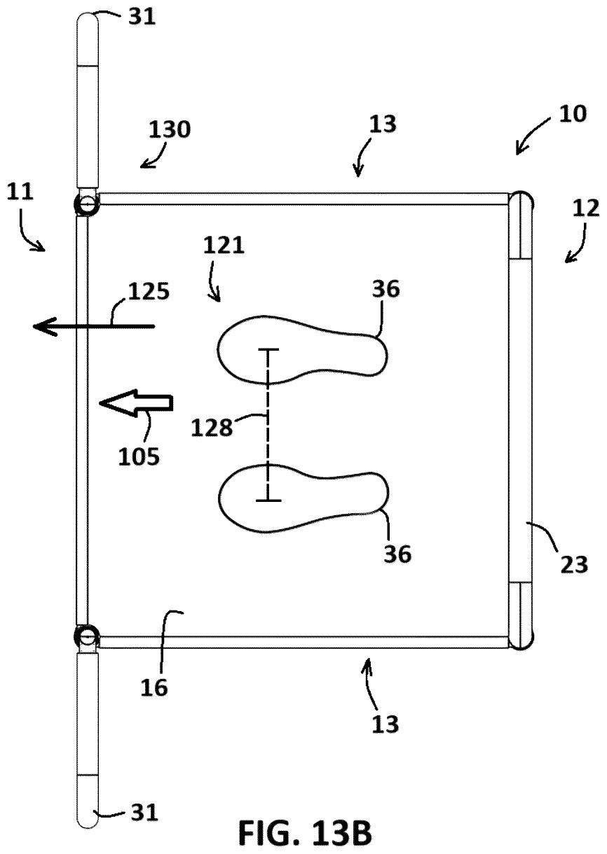

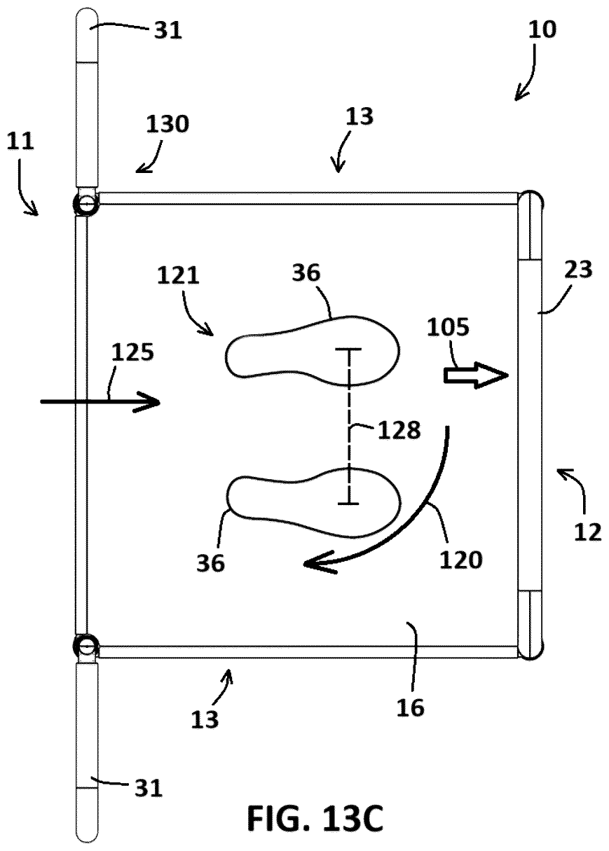

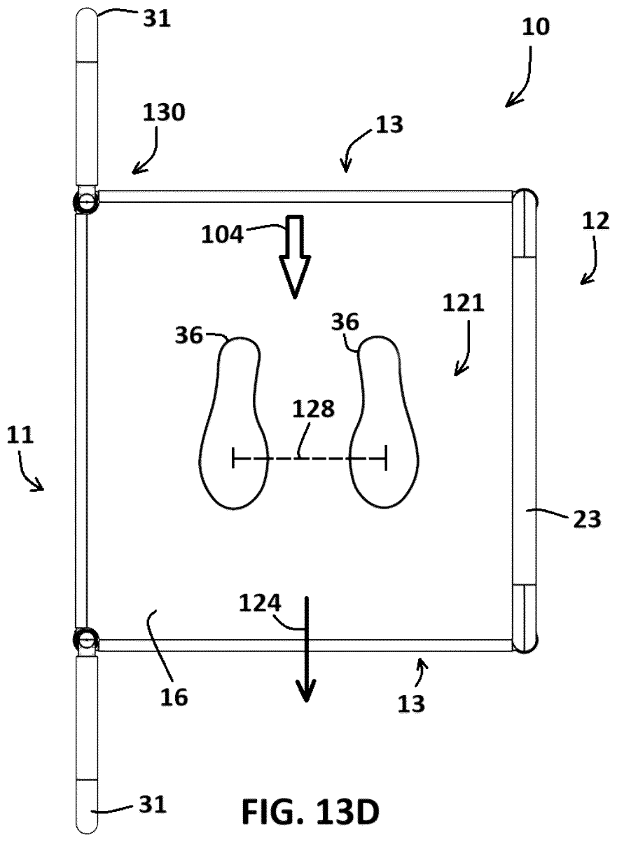

The bed step apparatus 10 essentially provides a platform 16 upon which a user may step, stand, and turn as at arrow 120 in FIGS. 13A and 13C, which platform 16 is elevated relative to the reference support surface 100 upon which the bed step apparatus 10 may be positioned adjacent the select bedside. When positioned adjacent the select bedside, the user may step upon the platform 16 via either of the laterally opposed platform access sides 13 so as to firstly elevate oneself relative to the reference support surface 100 and reduce the distance to the upper bed surface 116 of the bed 111. The bed entry process is partially demonstrated in FIGS. 13A and 13B. Similarly, when the user wishes to exit the bed 111, the distance to the platform 16 from the upper bed surface 116 is lesser than the distance from the upper bed surface 116 to the reference support surface 100. The bed exit process is partially demonstrated in FIGS. 13C and 13C.

The bed step apparatus 10 helps the user more easily access the reference support surface 100 via the platform 16 for enhancing safe movement from the bed 111 when the user wishes to exit the bed 111. The platform 16 is configured to provide the user with ample room to maneuver oneself thereatop and specifically provides ample room so that the user can access the platform 16 via either of the laterally opposed platform access sides 13 to face a first direction as at arrow 104, and turn as at arrow 120 through 90 degrees to face a second direction as at arrow 105 orthogonal to the first direction 104. The pathway to or from the bed 111 via the bed step apparatus 10 comprises at least two primary vector components as at arrows 104 and 105.

In this regard, it is noted that entry into and exit from a bed 111 is not always so simple or safe particularly for certain users having disabilities and the like. Providing an elevated platform 16 upon which one may maneuver and turn is, for some users, a relatively safer structure as compared to a step apparatus of the types developed by Baiera. Notably, the Baiera step apparatuses have relatively narrow treads upon which the user is unable to turn or maneuver in two dimensions. The platform access sides 13 of the bed step apparatus 10 are configured to provide access to the platform 16 in either of the first directions 104 so as to enable the user to stand thereupon in a user stance 121 facing the first direction 104 as generally depicted and referenced in FIG. 13A. The bed-facing side 11 is configured to provide access to the upper bed surface 116 in a second direction 105 orthogonal to the first direction 104 as generally depicted and referenced in FIG. 13B. The platform 16 is configured with a sufficient platform length 122 and a sufficient platform width 123 to enable the user to turn the user stance 121 to face the second direction 105 from the first direction 104.

It will be understood the bed step apparatus 10 according to the presently disclosed subject matter provides an elevated support surface as at 117 intermediate the reference support surface 100 and an upper bed surface 116. In some embodiments, the elevated support surface 117 may comprise an anti-slip material to prevent slippage when a user steps upon the platform 16. To provide the basic stepping function, the bed step apparatus 10 according to the presently disclosed subject matter may be said to essentially comprise a bed-facing side 11, a back side 12 opposite the bed-facing side 11, and laterally opposed platform access sides 13 extending intermediate the bed-facing side 11 and the back side 12. The bed-facing side 11 is positionable next to a select bedside as selected from the group consisting of the head end or side 112, the foot end or side 113, the left bedside 114 and the right bedside 115.

The platform 16 of the bed step apparatus 10 extends intermediate the bed-facing side 11, the back side 12, and the opposed platform access sides 13, and extends in a platform plane as at 109 as referenced in FIGS. 3 and 3A. The platform 16 is supported by a platform support mechanism. The platform support mechanism supports the platform 16 in spaced relation relative to the reference support surface 100 and the upper bed surface 116. In some embodiments, platform support mechanism is vertically adjustable for adjusting a distance of the platform 16 relative to at least the reference surface 100. In some embodiments, the platform plane 109 may be adjustably spaced from the reference support surface 100 from 2-8 inches, for example.

At least one of the platform access sides 13 is configured to provide a user with access to the platform 16 in a first direction 104 so as to enable the user to stand thereupon in a user stance 121 facing the first direction 104. The bed-facing side 11 is configured to provide a user with access to the upper bed surface 116 in a second direction 105 orthogonal to the first direction 104. The platform 16 is configured with a sufficient platform length 122 and a sufficient platform width 123 to enable the user to turn the user stance 121 to face the second direction 105 from the first direction 104. The platform length 122 and the platform width 123 are greater than a stance distance of a normalized user stance.

In most applications, the bed step apparatus 10 is configured to be positioned primarily at either the right bedside 115 or the left bedside 114 as comparatively depicted in FIGS. 9A and 9B. The laterally opposed platform access sides 13 define entry ways to the platform 16 or platform entry ways 124. The platform entry ways 124 extend bidirectionally and parallel to the select bedside in the first direction 104 or bidirectionally along a first dimension. The bed-facing side 11 further defines an entry way to the select bedside or bedside entry way 125. The bedside entry way 125 extends bidirectionally and perpendicular to the select bedside in the second direction 105 or bidirectionally along a second dimension orthogonal to the first dimension. The platform 16 is configured to allow a user to stand thereupon in the user stance 121 and maneuver oneself with sufficient space atop the platform 16 to redirect from either of the platform entry ways 124 to the bedside entry way 125.

In other words, the bed step apparatus 10 provides at least one entry way as exemplified by one or both platform entry ways 124 and a second entry way as exemplified by the bedside entry way 125. The user enters through either of the first or platform entry ways 124 and approaches a central portion of the platform 16. The user then may then turn as at arrow 120 and approach the second or bedside entry way 125 to further migrate therethrough to gain entry to the upper bed surface 116. It will thus be seen the bed step apparatus 10 differs from the Baiera bed step stool(s) introduced hereinabove in that the bed step apparatus 10 provides an indirect, two-vector pathway to the upper bed surface 116 whereas the Baiera apparatus provides a direct, single vector pathway to the upper bed surface. The platform length 122 and the platform width 123 are each greater than a normalized stance distance 128 of the user stance 121 generally depicted in FIGS. 13A through 13D.

It is noted there is great degree of variability in preferred stance width and foot angle across users. Some studies have shown that the average preferred foot position is about 7 inches between heel centers, with an angle of 14 degrees between the long axes of the feet generally depicted at footprints 36 in FIGS. 13A-13D. Assuming the normalized stance distance 128 my range from 12 inches to 24 inches or roughly shoulder width (16-24 inches for men and 12-20 inches for women), each of the platform length 122 and the platform width 123 should preferably exceed these dimensions. In some embodiments, the platform length 122 and the platform width 123 are each on the order of 36 inches, for example.

In some embodiments, the platform length 122 may differ from the platform width 123 while in other embodiments, the platform length 122 may equal the platform width 123. Accordingly, in some embodiments, the platform 16 may be rectangular in form and in some embodiments, the platform 16 may be square in form. In some applications, a square platform 16 may aid the user in judging space available upon the platform 16 when facing either of the first or second directions. The visual cue of either a given visible platform length 122 or a platform width 123 when facing a select direction helps the user judge spatial relationship of the length to width even though sides of the platform 16 may not be viewable or visible when standing thereupon.

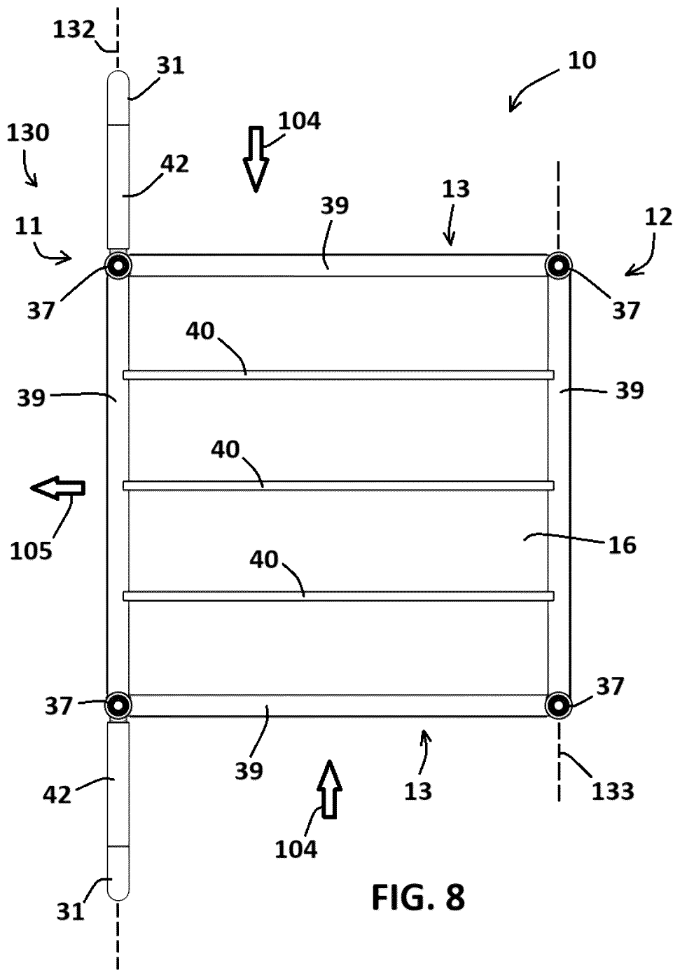

The platform 16 is raised relative to the reference support surface 100 by way of a platform support mechanism as prefaced above. In some embodiments, the platform support mechanism may comprise an array of support posts 18 at four corners 19 of the platform 16 in some embodiments. In some embodiments, the support posts 18 extend through post-receiving collars or post support collars 20 formed at each of the four corners 19 at the lower end 126 of the bed step apparatus 10. The post support collars 20 are interconnected by primary support members 39. In some embodiments, secondary support members 40 may extend intermediate and connect opposed primary support members 39 as generally depicted and referenced in FIG. 8. The secondary support members 40 help support the platform 16 extending intermediate the front or bed-facing side 11, the back side 12 and the laterally opposed platform access sides 13.

In some embodiments, the array of support posts 18 are selectively displaceable relative to the post support collars 20 so as to enable the user to vary the distance between the platform 16 and the support surface 100. In some embodiments, each of the support posts 18 at the lower end 126 of the bed step apparatus 10 may be outfitted with a post foot 37 for interfacing intermediate the support posts 18 and the reference support surface 100. In some applications, for example, the reference support surface 100 may be smooth. The post feet 37 may, in some embodiments, be formed from a high friction material to help prevent the bed step apparatus 10 from sliding over the reference support surface 100.

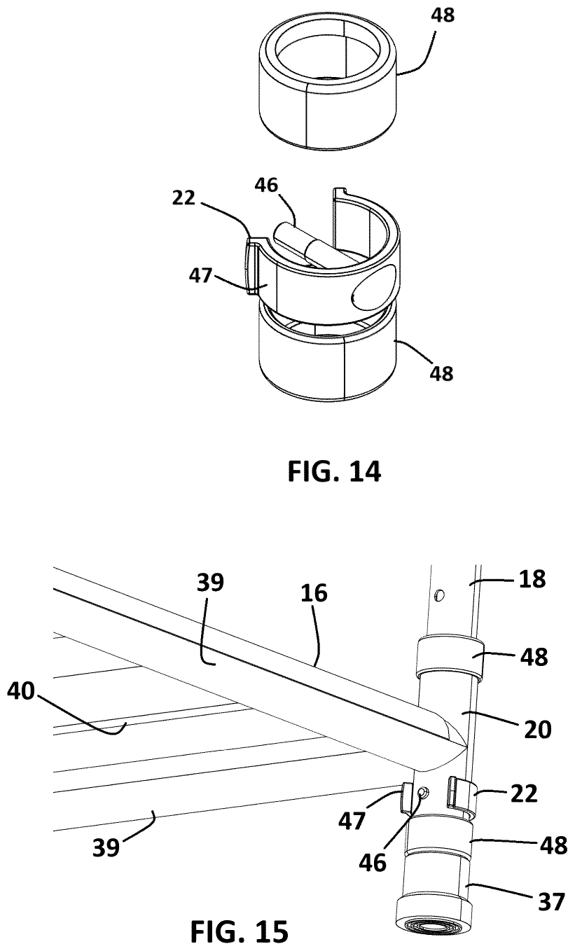

In some embodiments, the support posts 18 each comprise an array of pin-receiving apertures 21 disposed along the length thereof in spaced relation to one another and the post support collars 20 each cooperate with a platform-supporting pin mechanism 22. In some embodiments, the platform-supporting pin mechanisms 22 each comprise a pin element 46 and a C-shaped pin retainer 47 as generally depicted and referenced in FIGS. 14 and 15. The C-shaped pin retainers 47 mate with the post support collars 20 and hold the pin elements 46 within pin-receiving apertures 21 as the user may prefer to selectively lock the respective support posts 18 relative to the respective post support collars 20 to fix the distance of the platform 16 relative to the support surface 100.

The support posts 18 may be adjusted relative to the post support collars 20 by removing the platform-supporting pin mechanisms 22 from mated engagement with the post support collars 20 to dislocate the pin elements 46 from the pin-receiving apertures 21 after which the support posts 18 may be linearly displaced along the support axes of rotation 143. The platform-supporting pin mechanisms 22 may then be reattached to the post support collars 20 and the pin elements 46 may be relocated in successive pin-receiving apertures 21 to fix the platform 16 at a successive and preferred distance relative to the reference support surface 100. In some embodiments, the post support collars 20 may be outfitted with collar caps 48 at the upper and lower ends of the post support collars 20.

The back side 12 is characterized by comprising a back side support rail or upright 23 comprising laterally opposed uprights 24 and a top hand support rail 25. In some embodiments, the top hand rail 25 comprises radiused portions 26 at the laterally opposed uprights 24. Lower ends 27 of the laterally opposed uprights 24 are matable with upper ends 28 of support posts 18 at the back side 12. In some embodiments, the lower ends 27 of the laterally opposed uprights 24 are telescopically matable with the upper ends 28 of the support posts 18. In some embodiments, the lower ends 27 of the laterally opposed uprights 24 are telescopically receivable in the upper ends 28 of the support posts 18.

In some embodiments, the laterally opposed uprights 24 are adjustable along a length thereof relative to the support posts 18 and the platform 16 by way of a spring-biased pin mechanism 32 and an array of pin-receiving apertures 29 formed at the upper ends 28 of the support posts 18. In some embodiments, the pin-receiving apertures 29 are formed along a dimension extending orthogonally to the pin-receiving apertures 21 formed at the lower ends 30 of the support posts 18. In some embodiments, the support posts 18 may be outfitted with post caps 49 at the upper ends 28 of the support posts 18.

The front or bed-facing side 11 of the bed step apparatus 10 is characterized by laterally opposed and adjustable hand support rails 31 in some embodiments. The hand support rails 31 are similarly adjustable relative to upper ends 28 of the support posts 18 at the front or bed-facing side 11 by way of spring-biased spring mechanisms 32. In this regard, the hand support rails 31 are attached to front side posts 33, which are telescopically matable with the support posts 18 at the front side 11 in some embodiments. The hand support rails 31 are attachable to upper ends 35 of the front side posts 33 via the spring-biased mechanisms 32 matable with pin-receiving apertures 34 formed in the upper rends of the front side posts 33. In some embodiments, the front side posts 33 are circular in transverse cross-section and comprise an array of circumferentially spaced pin-receiving apertures 34 at upper ends 35 thereof. In some embodiments, the array of pin-receiving apertures 34 are directed at circumferentially spaced positions about the circumference of the front side posts 33 at the upper ends 35. This feature enables the user to fix the hand support rails 31 in any of the open configuration(s) 130 and the closed configuration 131.

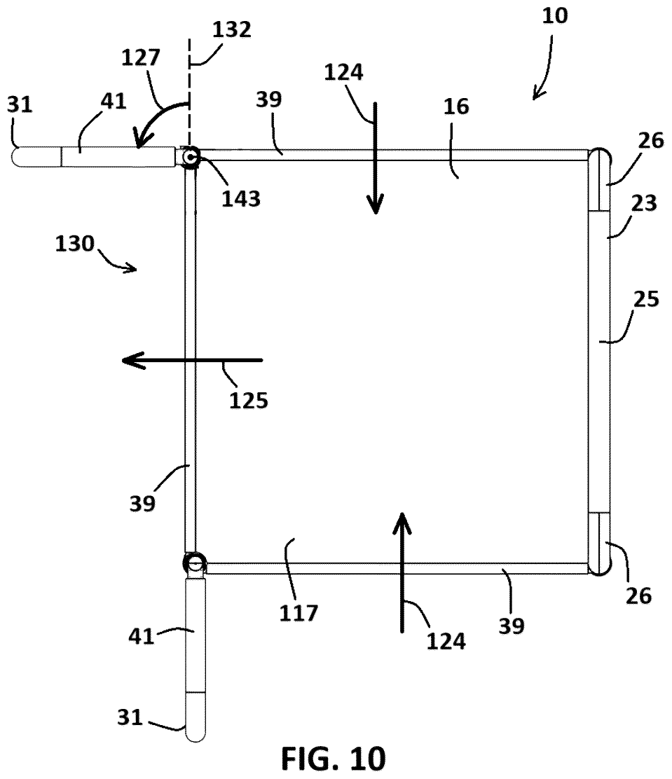

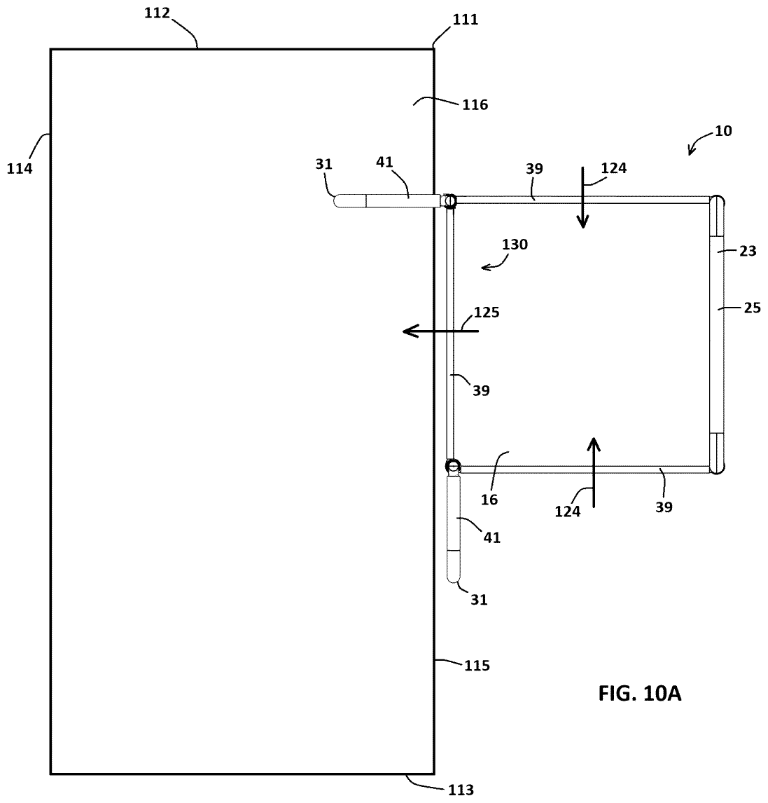

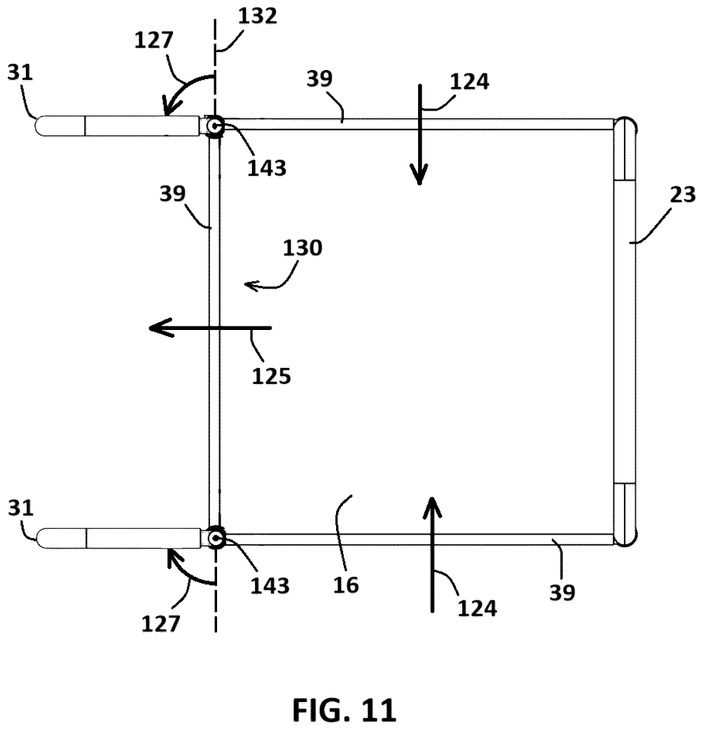

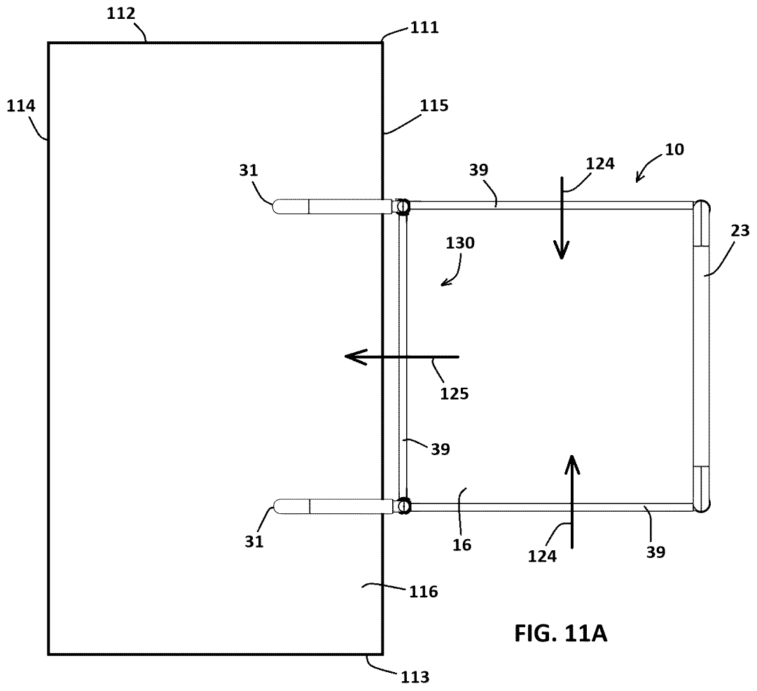

More particularly, the array of pin-receiving apertures 34 enable the user to pivot as at arrow 127 the hand support rails 31 about support axes of rotation 143 defined by the support posts 18 and front side posts 33 at the bed-facing side 11 for enabling the user to configure the hand support rails 31 in a variety of positions, including directions extending parallel to the select bedside as shown in FIGS. 9A-9D and directions orthogonal to the select bedside as shown in FIG. 11A. FIGS. 10 and 10A show the two hand support rails 31 with a first hand support rail 31 directed in a parallel direction relative to the select bedside and a second hand support rail 31 orthogonal to the select bedside for comparison purposes. The pivotal hand support rails 31 enable the user to reconfigure them for providing better support function when in the open configuration 130 and further enable the user to close the bedside entry way 125 when the bed step apparatus 10 into the closed configuration 131 as the user may elect.

The closed configuration 131 may help corral the user atop the upper bed surface 116 preventing the user from entering the space above the platform 16 during the night or while the user is sleeping atop the upper bed surface 116, for example. In other words, in some embodiments, the hand support rails 31 may provide a side rail or gate mechanism for preventing the user from falling from the bed 111 or preventing the user to freely enter-exit the bed 111 as at stop arrow 125′ otherwise indicating a closed bedside entry way. In some embodiments, the hand support rails 31 may be used as bed rails. The front side posts 33 are also length adjustable relative to the support posts 18 at the front or bed-facing side 11 by way of spring-biased pin mechanisms 32 and the pin-receiving apertures 34 substantially as earlier described.

In some embodiments, the hand support rails 31 at the bed-facing side 11 include a first hand support rail 31 and a second hand support rail 31 spaced from the first hand support rail 31. The first and second hand support rails 31 are configured to provide access to the upper bed surface 116 through a maximized surface access configuration generally exemplified by the open configuration 130 and as generally referenced in FIGS. 9A-11A. In some applications, the first and second hand support rails 31 are alignable in a first hand rail support plane 132 as generally referenced in FIG. 9A-9D. In some applications, the back side 12 comprises a third hand support rail 23, which third hand support rail 23 extends in a second hand support plane 133 parallel to the first hand support plane 132. The first and second hand support planes 132 and 133 together define an apparatus access pathway extending bidirectionally at least along the first direction(s) 104 or the first dimension.

In some embodiments, at least one of the first and second hand support rails 31 are pivotal about the support axis of rotation 143 for defining a minimized surface access configuration as exemplified by the closed configuration 131 referenced in FIGS. 12-12C. In some embodiments, at least one of the first and second hand support rails 31 are vertically adjustable along the support axis of rotation 143 for adjusting a bedside height thereof relative to the reference surface 100 and the upper bed surface 116. In some embodiments, the third hand support rail 23 is adjustable within the second hand support plane 133 for vertically adjusting a back side height thereof relative to the reference surface 100 and the upper bed surface 116.

In some embodiments, at least one of the first and second hand support rails 31 comprises an upper hand support portion 41 and a lower hand support portion 42. In some embodiments, the upper hand support portions 41 are parallel to the lower hand support portions 42 and the hand support rails 31 each further comprise a connecting portion 43. The upper hand support portion 41 and the lower hand support portion 42 are further connected to a post element 45 opposite the connecting portion 43, which post element 45 mates with the front side post 33 along the support axis of rotation 143.

In some embodiments, the connecting portion 43 may be radiused as at radius portions 52 at the upper hand support portion 41 and the lower hand support portion 42 similar to radiused portions 26. In some embodiments, the upper and lower hand support portions 41 and 42 together provide a bifurcated gate 55 when aligned in the first hand support plane 132 in the closed configuration 131 for preventing the user from entering a space above the platform 16 from the upper bed surface 116 as generally depicted and referenced in FIGS. 12B and 12C. In some embodiments, the hand support rails 31 and the hand support rail 23 may comprise an exterior hand grip material 44 for enabling the user to better grasp the hand rails 31 and 23.

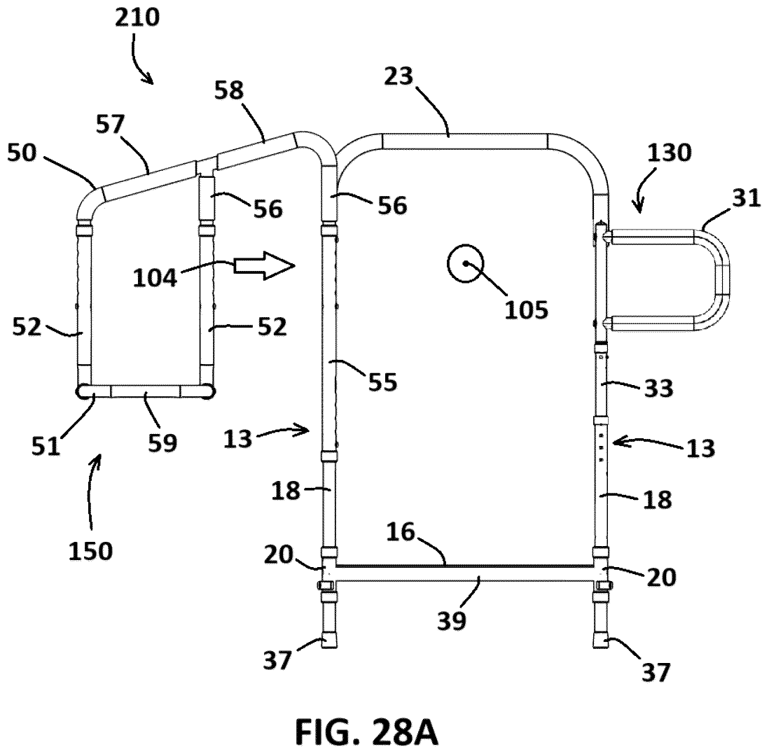

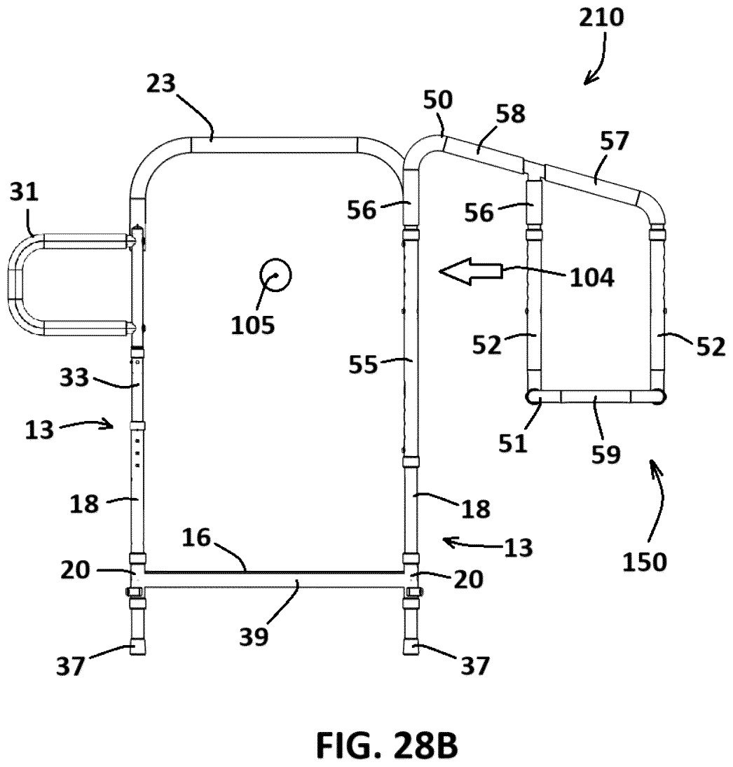

The second bed step apparatus 210 according to the presently disclosed subject matter is substantially similar to the first bed step apparatus 10 in most aspects, including features associated with the back side 12 and features associated with the platform 16 and the platform support mechanism. The primary structural differences between the second bed step apparatus 210 and the first bed step apparatus 10 are at the bed-facing side 11. The second bed step apparatus 210 comprises a handrail-anchor assembly 150 at the bed-facing side 11 at either one of the platform access sides 13. The second bed step apparatus 210 depicted in FIGS. 21-28A show the handrail-anchor assembly 150 at a first platform access side 13 of the second step apparatus 210. For comparison purposes, the handrail-anchor assembly 150 is positioned at a second platform access side 13 opposite the first platform access side 13 as depicted in FIG. 28B. Whether to position the handrail-anchor assembly 150 at the first platform access side 13 or the second platform access side 13 is generally dependent on user preference or the bedroom layout. The user will recall the second bed step apparatus 210 is asymmetrical about the main apparatus plane 110 as generally depicted in FIG. 22.

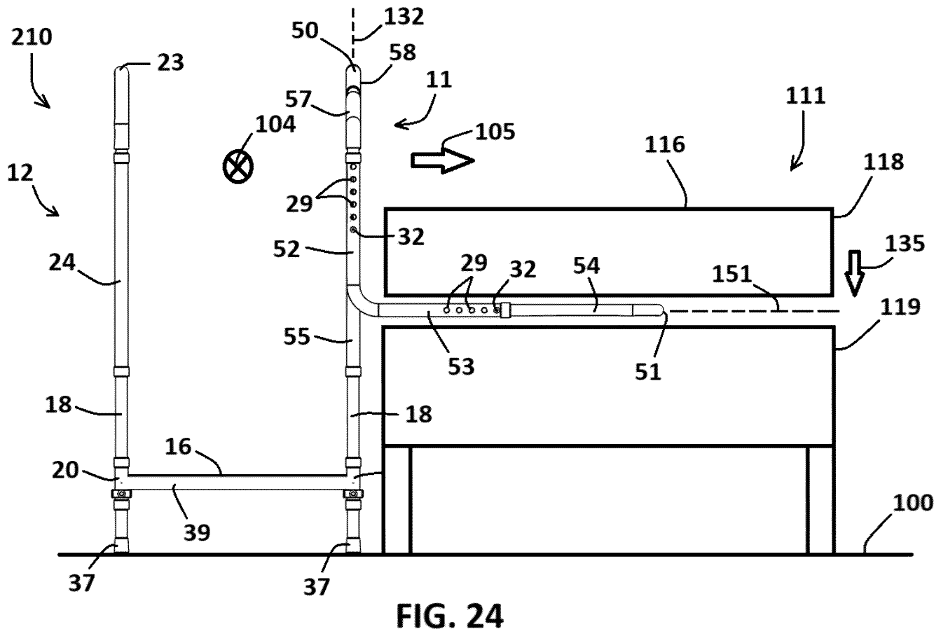

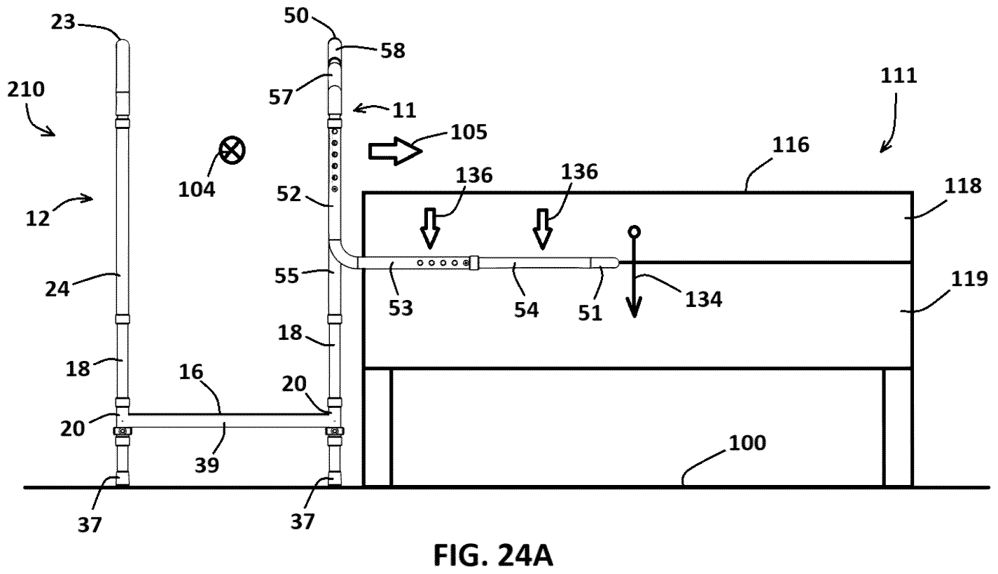

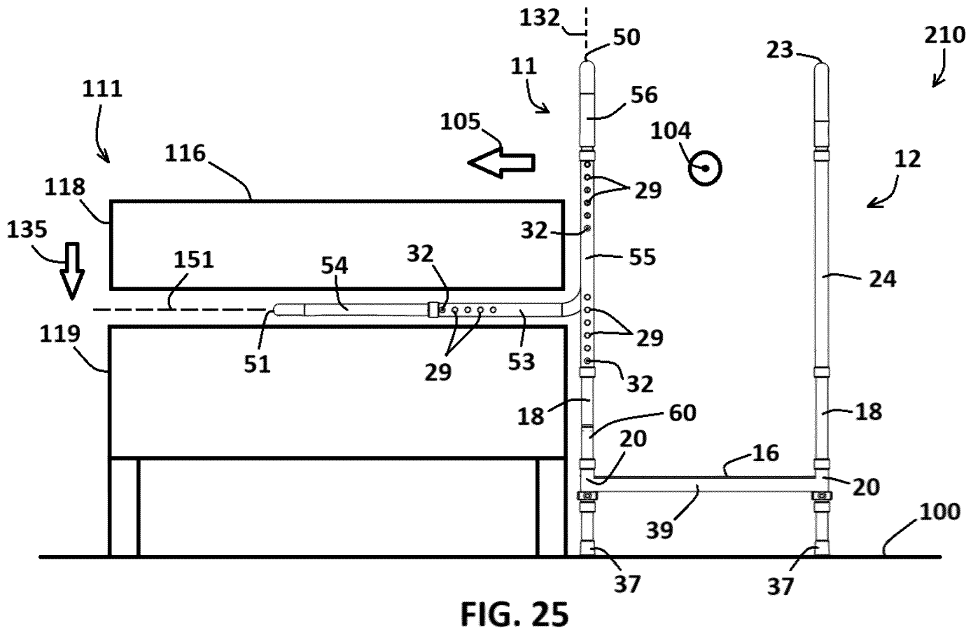

The handrail-anchor assembly 150 of the second bed step apparatus 210 comprises a handrail portion 50 and an apparatus anchor assembly 51. The handrail portion 50 extends in first hand rail support plane 132. The apparatus anchor assembly 51 extends in an anchor plane 151 orthogonal to the first hand rail support plane 132 in a direction toward the bedside of choice. The second bed step apparatus 210 is designed to provide enhanced stability of the second bed step apparatus 210 as secured or anchored in part by separable portions of the bed 111. In this regard, the handrail-anchor assembly 150 may be anchored or secured to the bed 111 by sandwiching the apparatus anchor assembly 51 intermediate a mattress 118 and a box spring 119 of the bed 111. A mattress 118 and a box spring 119 of the bed 111 are depicted and referenced in FIGS. 24-25. Referencing FIGS. 24 and 25, the reader will there consider the mattress 118 being directed downwardly as at arrow 135 atop the apparatus anchor assembly 51.

The weight as at arrow 134 in FIG. 24A of the mattress 118 directs or presses the mattress 118 against the apparatus anchor assembly 51 as at arrows 136 thereby helping to secure or anchor the apparatus anchor assembly 51 intermediate the mattress 118 and the box spring 119, in some applications. It is noted that not all beds 111 comprise a box spring 119. Essentially, the apparatus anchor assembly 51 is sandwiched intermediate an upper weighty structure and a lower structure such that the weight of the upper structure operates to help secure or anchor the apparatus anchor assembly 51 therebetween. The apparatus anchor assembly 51 is further connected to the handrail portion 50 which is connected to a support post 18 at the bed-facing side 11 thereby further stabilizing the second bed step apparatus 210 upon the support surface 100.

In some embodiments, the apparatus anchor assembly 51 comprises a U-shaped anchor extension member comprising opposed anchor members 54 and an anchor cross-member 59 extending therebetween. In some embodiments, radiused portions connect the anchor cross-member 59 to the opposed anchor members 54. Structurally, the U-shaped anchor extension member is similarly configured as compared to the back side support rail or upright 23 comprising laterally opposed uprights 24 and the top hand support rail 25. The opposed anchor members 54 similarly mate with anchor posts 53, which anchor posts 53 are structurally analogous to the support posts 18. The anchor posts 53 and the U-shaped anchor extension member extend along the anchor plane 151 orthogonal to the handrail portion 50 extending in the first hand rail support plane 132. In some embodiments, the opposed anchor members 54 telescopically mate with anchor posts 53, which comprise an array of pin-receiving apertures 29 formed along a length thereof for cooperating with a spring-biased pin mechanism 32 of each anchor member 54 substantially as earlier described.

The anchor posts 53 are connected to opposed support posts 52 of the handrail portion 50 via radiused portions which radiused portions provide the orthogonal relationship between the apparatus anchor assembly 51 and the handrail portion 50. The support posts 52 of the handrail portion 50 are structurally analogous to the anchor posts 53 in some embodiments, and each comprises an array of pin-receiving apertures 29 formed along the lengths thereof. The arrays of pin-receiving apertures 29 of the support posts 52 cooperate with a spring-biased pin mechanism 32 associated with each of a first handrail connection end 61 and an adjacent second handrail connection end 56.

A third handrail connection end 56, substantially the same as the second handrail connection end 56, mates the handrail portion 50 to an upright member 55, which upright member 55 mates with a support post 18 at the bed-facing side 11. The upright member 55 comprises two sets of pin-receiving apertures 29. A first set of pin-receiving apertures 29 is formed along a length thereof at an upper end of the upright member 55 and a second set of pin-receiving apertures 29 is formed along a length thereof at a lower end of the upright member 55. In some embodiments, the support post 18 at the bed-facing side 11, telescopically matable with the upright member 55, comprises a spring-biased pin mechanism 32 cooperable with the array of pin-receiving apertures 29 at the lower end of the upright member 55 for adjusting the vertical height thereof. All pin-receiving apertures 29 cooperable with a spring-biased pin mechanism 32 enable the user to adjust the length of opposed members.

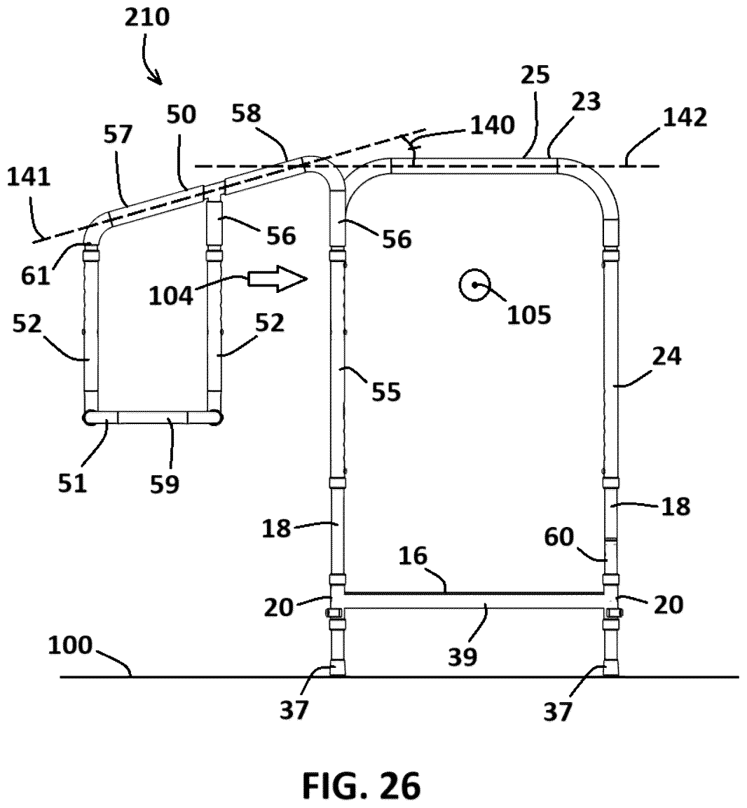

The handrail portion 50 further comprises a first handrail cross-member 57 interconnecting the first handrail connection end 61 and the second handrail connection end 56. A second handrail cross-member 58 interconnects the second handrail connection end 56 and the third handrail connection end 56. In some embodiments, the first handrail cross-member 57 and the second handrail cross-member 58 are axially aligned and extend along a handrail plane 141 as referenced in FIG. 26. In some embodiments, the handrail plane 141 is obliquely angled relative to a handrail plane 142 of the top hand support rail 25 at the back side 12. Further referencing FIG. 26, the reader will there consider oblique angle 140 extending between the handrail plane 141 of the handrail portion 50 and the handrail plane 142 of the top hand support rail 25. The obliquely angled handrail cross-members 57 and 58 aid the user to step upon the platform 16 in the first direction 104 when entering the second bed step apparatus 210 and help the user step from the platform 16 when exiting the second bed step apparatus 210.

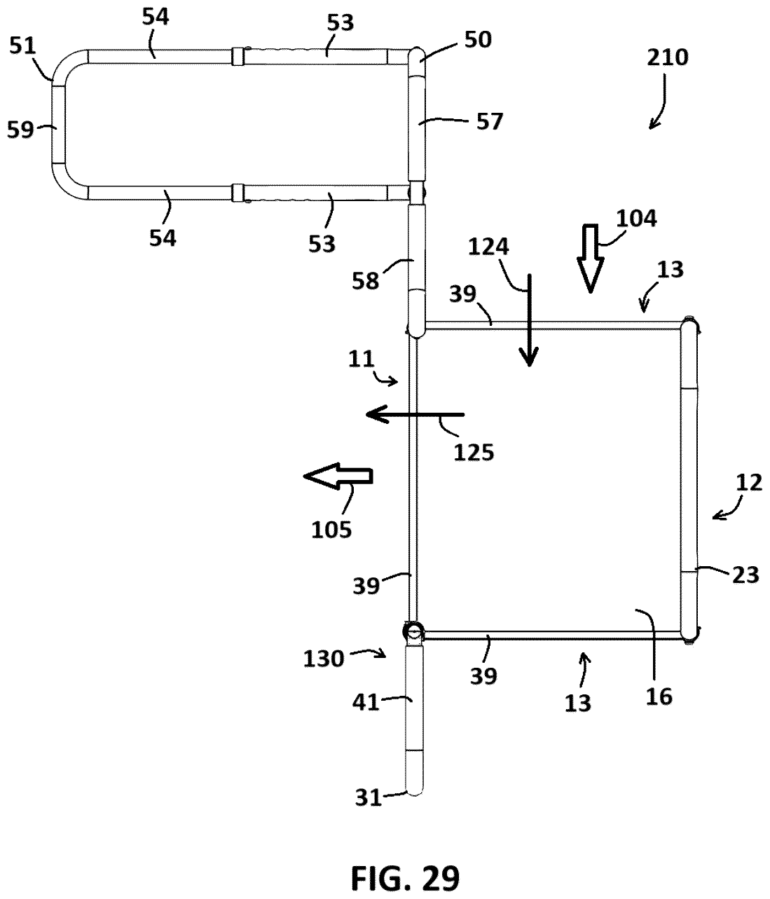

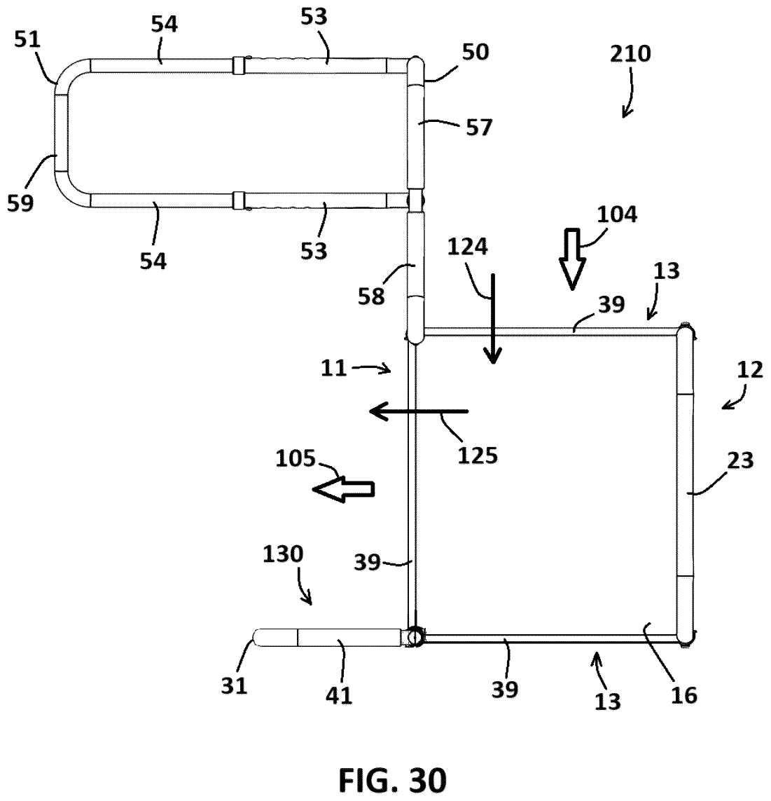

Reference is further made to a relatively short placeholder post 60 in FIGS. 21, 22, 25 and 26. For ease of illustration, handrail structures at the second platform access side 13 opposite the first platform access side 13 to which the handrail-anchor assembly 150 is attached have been removed in FIGS. 21, 22, 25 and 26. In some embodiments, the second platform access side 13 opposite the first platform access side 13 to which the handrail-anchor assembly 150 is attached may be outfitted with an adjustable hand support rail 31 as generally depicted in FIGS. 28A-32. The adjustable hand support rail 31 at the second platform access side 13 is substantially as earlier described in connection with the first bed step apparatus 10. The first open configuration 130 of the hand support rail 31 is generally depicted and referenced in FIGS. 28-29. The second open configuration 130 of the hand support rail 31, 90 degrees from the first open configuration 130, is generally depicted and referenced in FIG. 30.

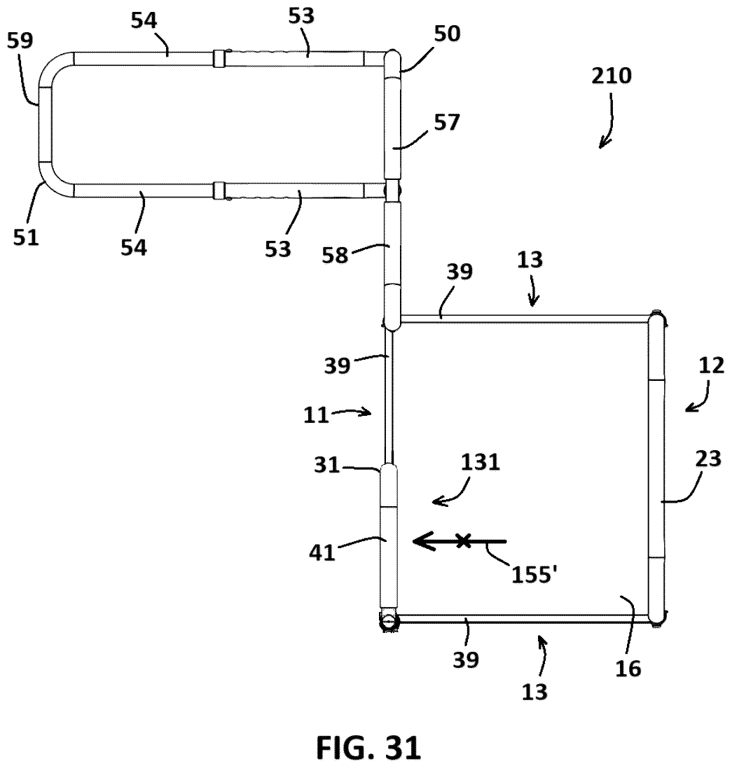

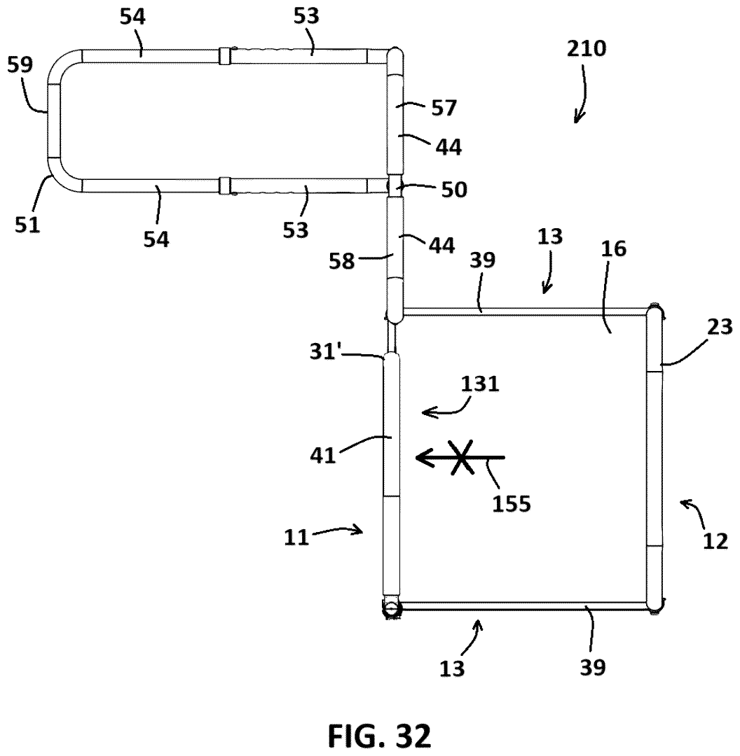

Referencing FIGS. 31 and 32, the reader will there consider closed configuration(s) 131/131′ of the hand support rail 31. The closed configuration 131 depicted in FIG. 31 shows a first minimized bedside entry way as at stop arrow 155′ with a relatively small X across the stop arrow 155′. In this regard, the reader will note the second bed step apparatus 210 does not comprise opposed pivotal hand support rails 31. Accordingly, the second bed step apparatus 210 does not provide a bifurcated gate 55 for providing a closed bedside entry way otherwise referenced at stop arrow 125′. To provide a fully closed bedside entry way, the second bed step apparatus 210 may comprise a hand support rail 31′ that is relatively longer as compared to the hand support rail 31 for enabling the user to close the bedside or provide a closed bedside entry way 155 as depicted and referenced in FIG. 32 with a relatively large X across the stop arrow 155. The bed step apparatus 210 may be said to provide a gate for providing a closed bedside entry way 155 in some embodiments, which gate may be exemplified by the hand support rail 31′, which gate functions in very much the same manner as the bifurcated gate 55 described hereinabove.

While the above descriptions contain much specificity, this specificity should not be construed as limiting the scope of the presently disclosed subject matter, but rather as exemplifications of the presently disclosed subject matter. The basic invention may be said to essentially teach or disclose a step apparatus for providing an elevated support surface intermediate a reference support surface and a target support surface as exemplified by an upper bed surface. The step apparatus according to the presently disclosed subject matter comprises a front side, a back side, and laterally opposed platform access sides. The front side is positionable adjacent the target support surface.

The step apparatus further comprises a platform extending intermediate the front side, the back side, and the laterally opposed platform access sides. A platform support mechanism supports the platform in spaced relation relative to the reference surface and the target support surface. At least one of the platform access sides is configured to provide access to the platform in a first direction so as to enable the user to stand thereupon in a user stance facing the first direction. The front or bed-facing side is configured to provide access to the target support surface in a second direction orthogonal to the first direction, and the platform is dimensioned or configured to enable the user to turn the user stance to face the second direction from the first direction.

In some embodiments, the front side comprises a first support rail and a second support rail spaced from the first support rail configured to provide access to the target support surface when in an open configuration. The first support rail may be defined by either a hand support rail 31, a hand support rail 31′ or a handrail-anchor assembly 150. When the first support rail is defined by a handrail-anchor assembly 150, the second support rail may be defined by either a hand support rail 31 or a hand support rail 31′. In some embodiments, the first and second support rails are pivotal about a support axis of rotation and alignable in a first support plane to effect either the open configuration or a closed configuration.

In some embodiments, the back side may comprise a third support rail, which third support rail extends in a second support plane parallel to the first support plane. The first and second support planes define an apparatus access pathway extending at least along the first direction. In some embodiments, at least one of the first, second and third support rails are vertically adjustable for adjusting a height thereof relative to the reference surface and the target support surface. In some embodiments, at least one of the first and second support rails comprises an upper support portion and a lower support portion.

In some embodiments, the upper and lower support portions of a single support rail of opposed support rails together provide a gate for preventing the user from entering a space above the platform from the target support surface. In those embodiments deploying first and second support rails that pivot, the upper and lower support portions provide a bifurcated gate when aligned in the first support plane in the closed configuration or gate mechanism for preventing the user from entering a space above the platform from the target support surface. In some embodiments, the platform support mechanism is adjustable for vertically adjusting a distance of the platform relative to at least the reference support surface.

Noting that the user stance comprises a stance distance, the platform comprises a platform length and a platform width. Each of the platform length and the platform width are greater than the stance distance so as to easily enable the user to turn the user stance to face the second direction from the first direction. In some embodiments, the platform length equals the platform width thereby providing a square platform, which may aid the user in judging space available upon the platform when facing either of the first or second directions. The visual cue of either a platform length or platform width when facing a select direction helps the user judge spatial relationship of the platform length to platform width even though sides of the platform may not be viewable when standing thereupon.

Accordingly, although the step apparatus according to the presently disclosed subject matter has been described by reference to a number of embodiments, it is not intended that the step apparatus be limited thereby, but that modifications thereof are intended to be included as falling within the broad scope and spirit of the foregoing disclosure, the following claims, and the appended drawings.

What is claimed is:

1. A bed step apparatus for providing an elevated support surface intermediate a reference support surface and an upper bed surface, the bed step apparatus comprising:
a bed-facing side, a back side opposite the bed-facing side, and opposed platform access sides extending intermediate the bed-facing side and the back side, the bed-facing side being positionable next to a bedside;
a platform extending intermediate the bed-facing side, the back side, and the opposed platform access sides, the platform extending in a platform plane; and
a platform support mechanism, the platform support mechanism supporting the platform in spaced relation relative to the reference surface and the upper bed surface;
at least one of the platform access sides being configured to provide access to the platform in a first direction so as to enable the user to stand thereupon in a user stance facing the first direction;
the bed-facing side being configured to provide access to the upper bed surface in a second direction orthogonal to the first direction, the platform being configured to enable the user to turn the user stance to face the second direction from the first direction.

2. The bed step apparatus according to claim 1, wherein the bed-facing side comprises a first hand support rail and a second hand support rail spaced from the first hand support rail, the first and second hand support rails being configured to provide access to the upper bed surface by way of at least one open configuration.

3. The bed step apparatus according to claim 2, wherein the first and second hand support rails are alignable in a first hand rail support plane.

4. The bed step apparatus according to claim 3, wherein the back side comprises a third hand support rail, the third hand support rail extending in a second hand support plane parallel to the first hand support plane, the first and second hand support planes defining an apparatus access pathway extending at least along the first direction.

5. The bed step apparatus according to claim 2, wherein at least one of the first and second hand support rails are pivotal about a support axis of rotation.

6. The bed step apparatus according to claim 4, wherein at least one of the first, second and third hand support rails are vertically adjustable for adjusting a height thereof relative to the reference surface and the upper bed surface.

7. The bed step apparatus according to claim 5, wherein the first and second hand support rails comprise an upper hand support portion and a lower hand support portion, the upper and lower hand support portions together providing a bifurcated gate when aligned in the first hand support plane and in a closed configuration for preventing the user from entering a space above the platform from the upper bed surface.

8. The bed step apparatus according to claim 1, wherein the platform support mechanism is vertically adjustable for adjusting a distance of the platform relative to at least the reference surface.

9. The bed step apparatus according to claim 2, wherein at least one of the first hand support rail and a second hand support rail comprises an apparatus anchor assembly, the apparatus anchor assembly being positionable intermediate an upper bed structure and a lower bed structure, a weight of the upper bed structure for securing the apparatus anchor assembly intermediate the upper and lower bed structures.

10. The bed step apparatus according to claim 1, wherein the platform comprises a platform length and a platform width, each of the platform length and the platform width being greater than a stance distance of the user stance.

11. A step apparatus for providing an elevated support surface intermediate a reference support surface and a target support surface, the step apparatus comprising:
a front side, a back side, and laterally opposed platform access sides, the front side being positionable adjacent the target support surface;
a platform extending intermediate the front side, the back side, and the laterally opposed platform access sides; and
a platform support mechanism, the platform support mechanism supporting the platform in spaced relation relative to the reference surface and the target support surface;
at least one of the platform access sides being configured to provide access to the platform in a first direction so as to enable the user to stand thereupon in a user stance facing the first direction; and
the front side being configured to provide access to the target support surface in a second direction orthogonal to the first direction, the platform being configured to enable the user to turn the user stance to face the second direction from the first direction.

12. The step apparatus according to claim 11, wherein the front side comprises a first support rail and a second support rail spaced from the first support rail configured to provide access to the target support surface when in an open configuration.

13. The step apparatus according to claim 12, wherein the first and second support rails are pivotal about a support axis of rotation and alignable in a first support plane to effect either the open configuration or a closed configuration.

14. The step apparatus according to claim 13, wherein the back side comprises a third support rail, the third support rail extending in a second support plane parallel to the first support plane, the first and second support planes defining an apparatus access pathway extending at least along the first direction.

15. The step apparatus according to claim 14, wherein at least one of the first, second and third support rails are vertically adjustable for adjusting a height thereof relative to the reference surface and the target support surface.

16. The step apparatus according to claim 12, wherein at least one of the first and second support rails comprises an upper support portion and a lower support portion.

17. The step apparatus according to claim 16, wherein the upper and lower support portions provide together provide a bifurcated gate when aligned in the first support plane in a closed configuration for preventing the user from entering a space above the platform from the target support surface.

18. The step apparatus according to claim 11, wherein the platform support mechanism is adjustable for adjusting a distance of the platform relative to at least the reference support surface.

19. The step apparatus according to claim 12 wherein at least one of the first and second support rails comprises an apparatus anchor assembly, the apparatus anchor assembly being positionable intermediate an upper structure and a lower structure, a weight of the upper structure for securing the apparatus anchor assembly intermediate the upper and lower structures.

20. The step apparatus according to claim 11, wherein the platform comprises a platform length and a platform width, each of the platform length and the platform width being greater than a stance distance of the user stance.
